(19) United States
(12) Patent Application Publication
(10) Pub. No.: US 2019/0256991 A1
(43) Pub. Date: Aug. 22, 2019

(54) GAS PERMEABLE ELECTRODES AND ELECTROCHEMICAL CELLS

(71) Applicant: AQUAHYDREX PTY LTD, NEW SOUTH WALES (AU)

(72) Inventors: Gerhard Frederick SWIEGERS, Woonona (AU); Jun CHEN, Balgownie (AU); Stephen Thomas BEIRNE, Farmborough Heights (AU); Caiyun WANG, Mangerton (AU)

(21) Appl. No.: 16/198,477

(22) Filed: Nov. 21, 2018

Related U.S. Application Data
(63) Continuation of application No. 14/564,910, filed on Dec. 9, 2014, now abandoned.

(30) Foreign Application Priority Data
Jun. 12, 2012 (AU) 2012902448

(51) Int. Cl. C25B 11/00; C25B 1/10; C25B 9/08; C25B 1/04; C25B 11/03

(52) U.S. Cl. CPC C25B 11/00; C25B 1/10; Y02E 60/366; C25B 1/04; C25B 11/035; C25B 9/08

(57) ABSTRACT

An electrode for a water splitting device, the electrode comprising a gas permeable material, a second material, for example a further gas permeable material, a spacer layer positioned between the gas permeable material and the second material, the spacer layer providing a gas collection layer and a conducting layer. The conducting layer can be provided adjacent to or at least partially within the gas permeable material. The gas collection layer is able to transport gas internally in the electrode. The gas permeable materials can be gas permeable membranes. Also disclosed are electrochemical cells using such an electrode as the cathode and/or anode, and methods for bringing about gas-to-liquid or liquid-to-gas transformations, for example for producing hydrogen.

### PRIORITY APPLICATIONS

The present application is a continuation of co-pending U.S. application Ser. No. 14/564,910 filed Dec. 9, 2014, which is a 371 application of International Application No. PCT/AU13/00617 filed Jun. 11, 2013, which claims priority to Australian Patent Application No. 2012902448 filed Jun. 12, 2012. The entire disclosure of each of the foregoing applications is hereby incorporated herein by reference.

### TECHNICAL FIELD

The present invention generally relates to electrochemical devices or cells, electrodes, methods of manufacture thereof, and/or methods for electrochemical or electrolytic reactions or processes. In particular aspects, the present invention relates to devices, cells, electrodes and/or methods for bringing about gas-to-liquid or liquid-to-gas transformations and, for example, to water electrolysis cells or electrodes that achieve water-splitting. In other examples, the present invention relates to methods of manufacturing electrodes and/or electrochemical devices or cells including the electrodes.

### BACKGROUND

The electrolytic splitting of water into hydrogen gas and oxygen gas is generally achieved by applying a current to two, closely located electrodes, typically made of platinum, each of which are in contact with an intermediate water solution. At one electrode—the anode—water is typically oxidized according to the half-reaction given in equation (1). At the other electrode—the cathode—protons (H′) are typically reduced according to the half reaction shown in equation (2). The overall reaction at the two electrodes is given in equation (3):

$$\begin{matrix}2 {H}_{2} O \to {O}_{2} + 4 {H}^{+} + 4 {e}^{-} ( anode ) & ( 1 ) \\ 4 {e}^{-} + 4 {H}^{+} \to 2 {H}_{2} ( cathode ) & ( 2 ) \\ 2 {H}_{2} O \to {O}_{2} + 2 {H}_{2} ( overall reaction ) & ( 3 )\end{matrix}$$

Numerous devices for splitting water electrolytically, known as water electrolysers, are commercially available. A common problem with commercially-available water electrolysers is that they are generally inefficient in their ability to convert electrical energy into energy within the hydrogen that they generate. That is, they display low energy efficiency in the transformation of water into hydrogen. Hydrogen is, of course, a fuel that could in the future supplant fossil fuels like gasoline and diesel. Moreover, it is potentially a non-polluting fuel since the only product of combusting hydrogen is water.

One kilogram of hydrogen contains the equivalent of 39 kWh of electrical energy within it (by its Higher Heating Value, or HHV, measure). However commercial electrolysers typically require substantially more electrical energy than 39 kWh to generate 1 kg of hydrogen. For example, the Stuart IMET 1000 electrolyser requires, on average, 53.4 kWh of electrical energy to generate 1 kg of hydrogen, giving it an overall energy efficiency for the conversion of water into hydrogen (HHV) of 73%. That is, approximately one quarter of the electrical energy fed into the electrolyser is wasted (largely as heat) and not harnessed to make hydrogen.

Similarly the Teledyne EC-750 electrolyser requires 62.3 kWh of electrical energy to make 1 kg of hydrogen (63% energy efficiency HHV). The Proton Hogen 380 electrolyser requires 70.1 kWh/kg of hydrogen (56% energy efficiency, HHV), while the Norsk Hydro Atmospheric type No. 5040 (5150 AmpDC) requires 53.5 kWh/kg of hydrogen generated (73% energy efficiency, HHV). The AvalenceHydrofiller 175 requires 60.5 kWh of electrical energy to generate 1 kg of hydrogen (64% energy efficiency, HHV).

In summary therefore, current commercially-available water electrolysers are relatively wasteful of electrical energy in their production of hydrogen. This inefficiency has severely disadvantaged hydrogen as, for example, a potential transportation fuel for a future economy.

For example, in the era of the George W. Bush presidency, the U.S.A. considered hydrogen to be strategically important as an alternative transportation fuel. However, since that time, in the Obama presidency, it has been recognised that electric batteries can provide a better overall efficiency for the conversion of grid electrical energy into automotive power than is achieved by the current commercial water electrolysers combined with the use of high-efficiency fuel cells (powered by hydrogen). The U.S.A. has, consequently, revised its strategic focus away from hydrogen-powered automobiles to electric-powered automobiles in the period 2009-2012. The Department of Energy in the U.S.A., nevertheless, has, as one of its critical targets, the development of water electrolysers which achieve 90% overall energy efficiency, HHV.

A key problem with current commercial water electrolysers is that they suffer from electrical losses caused by their operation at extremely high electrical current densities (of typically 1000-8000 mA/cm²). This is commercially unavoidable because the only way to achieve a low cost of production of hydrogen is to minimize the quantity of materials required in the electrolyser per kilogram of hydrogen that is generated. Many of the materials used in commercial electrolysers are exceedingly expensive—for example, the precious metal catalysts used at the anode/cathode and the proton exchange membrane diaphragm used to separate the gases. The only way to achieve a low overall price for the hydrogen produced, is therefore to generate the largest reasonable amount of hydrogen per unit area for the cost of manufacturing the electrolyser. In other words, a high current density is needed to lower the capital cost of the electrolyser per kilogram of hydrogen produced. The Department of Energy in the U.S.A. has, as another of its critical targets, the development of water electrolysers that minimise the quantity of precious metal catalysts and other expensive components required and thereby reduce the capital costs.

At such high current densities the energy losses which occur in the water-splitting process are large. These energy losses include Ohmic losses at the electrodes and within the electrolyte, as well as so-called overpotential losses, which occur when a larger voltage than is theoretically necessary must be applied to drive the water-splitting process. These losses combine to create the energy inefficiencies displayed by commercially-available water electrolysers.

In the Applicant's earlier International Patent Application No. PCT/AU2011/001603, the Applicant described a water splitting cell which employed spacers that allows the cell to be manufactured from inexpensive and thin materials. The key advantage of employing inexpensive manufacturing techniques to produce water splitting cells, is that it makes it commercially viable to build cells with large surface areas and operate them at low current densities. Much higher overall energy efficiencies can be realised in this way than is possible in present-day commercial water electrolysers. Traditional approaches to the manufacture of water electrolysers involve high capital expenditure which precludes the additional capital cost involved in manufacturing the large electrode areas required at low current densities.

Operating at low current densities leverages the ability to produce hydrogen at very high efficiencies. In such devices, it is important to minimise energy losses so that the operational efficiencies and reduced manufacturing costs compensate for the increase in electrode area.

An important energy loss is the so-called “bubble overpotential”, which occurs at both electrodes during the formation of gas bubbles of hydrogen (cathode) and oxygen (anode). For example, the concentrations of O₂ bubbles required not only produce overpotential at the anode, but also represent a very reactive environment that challenges the long term stability of many catalysts.

Low current densities are generally consistent with high energy efficiencies because they minimise the losses that occur, including Ohmic losses and the like, during the water-splitting reaction. However, it is presently not commercially feasible to use low current densities in current commercial water electrolysers because of the high cost of materials used in such devices.

In summary, there presently exists a pressing need to improve water electrolyser technology to achieve higher energy efficiency HHV and lower the overall cost of hydrogen manufactured by electrolytic water splitting. In one example problem, reducing or eliminating a key energy loss—the bubble overpotential—could diminish the energy losses and improve the overall energy efficiency of water splitting.

Numerous other electrochemical liquid-to-gas transformations have similar problems as those described above for water electrolysis, namely high costs of materials, which force the use of high current densities in the device or cell, with associated low overall energy efficiencies. For example, the electrochemical production of chlorine from brine (aqueous sodium chloride) is extremely wasteful of energy. The same is true for numerous electrochemical gas-to-liquid transformations. For example, hydrogen-oxygen fuel cells are generally only 40-70% energy efficient for similar reasons to those described above.

There is a need for electrochemical devices or cells, electrodes, methods of manufacture thereof, and/or methods for electrochemical or electrolytic reactions or processes, which address or at least ameliorate one or more problems inherent in the prior art, for example allowing higher energy efficiencies to be achieved.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Examples. This Summary is not intended to identify key features or essential features of the claimed subject matter, nor is it intended to be used to limit the scope of the claimed subject matter.

It will be convenient to describe embodiments of the invention in relation to electrochemical devices or cells, electrodes or methods for water splitting, however it should be appreciated that the present invention can be applied to other types of liquid-to-gas or gas-to-liquid electrochemical reactions.

In one form there is provided an electrode for a water splitting device, comprising a gas permeable material. Also included in the electrode, or as part of an associated electrode or anode/cathode, for example positioned adjacent the electrode, is a second material. A spacer layer is positioned between the gas permeable material and the second material, the spacer layer providing a gas collection layer, for example within the electrode, between an anode-cathode pair, an anode-anode pair or a cathode-cathode pair. A conducting layer is also provided as part of the electrode. The second material may be part of the electrode, or an associated or adjacent electrode, cathode or anode, and in one form may also be a gas permeable material.

Reference to a gas permeable material should be read as a general reference also including any form or type of gas permeable medium, article, layer, membrane, barrier, matrix, element or structure, or combination thereof.

Reference to a gas permeable material should also be read as including a meaning that at least part of the material is sufficiently porous or penetrable to allow movement, transfer, penetration or transport of one or more gases through or across at least part of the gas permeable material. The gas permeable material can also be referred to as a “breathable” material.

In various examples: the conducting layer is provided adjacent to or at least partially within the gas permeable material; the conducting layer is associated with the gas permeable material; the conducting layer is deposited on the gas permeable material; the gas permeable material is deposited on the conducting layer; and/or the gas collection layer is able to transport gas internally in the electrode. In another example, the gas permeable material is a gas permeable membrane. In another example, the second material is a further or additional gas permeable membrane.

Preferably, the gas collection layer is able to transport gas internally in the electrode to at least one gas exit area positioned at or near an edge or an end of the electrode.

In various other example aspects: the gas permeable material and the second material are separate layers of the electrode; the second material is part of an adjacent anode or cathode; the second material is a gas permeable material; and/or the second material is a gas permeable material and a second conducting layer is provided adjacent to or at least partially within the second material. Thus, in one example the spacer layer providing a gas collection layer is provided between a gas permeable layer and a second layer being a further gas permeable layer of the electrode. In another example, the second material is a gas permeable material and a second conducting layer is associated with, positioned adjacent to, or deposited on the second material.

In yet other example aspects: the electrode is formed of flexible layers; the electrode is at least partially wound in a spiral; and/or the conducting layer includes one or more catalysts.

In an example aspect, the spacer layer is positioned adjacent to an inner side of gas permeable material, and the conducting layer is positioned adjacent to, on or partially within an outer side of the gas permeable material.

Optionally, the gas permeable material is made at least partially or wholly from a polymer material, for example PTFE, polyethylene or polypropylene.

In other example aspects: at least a portion of the conducting layer is between the one or more catalysts and the gas permeable material; the spacer layer is in the form of a gas channel spacer; and/or the spacer layer includes embossed structures on an inner surface of the gas permeable material and/or the second material.

In another form there is provided an electrode for a water splitting device, comprising: a first gas permeable material; a second gas permeable material; a spacer layer positioned between the first gas permeable material and the second gas permeable material, the spacer layer providing a gas collection layer; a first conducting layer associated with the first gas permeable material; and, a second conducting layer associated with the second gas permeable material.

In various examples: the first conducting layer is provided adjacent to or at least partially within the first gas permeable material; the second conducting layer is provided adjacent to or at least partially within the second gas permeable material; the electrode is formed of flexible layers wound in a spiral; the electrode is formed of planar layers; the first conducting layer includes a catalyst; and/or the second conducting layer includes another catalyst.

In another form there is provided a water splitting device, comprising: an electrolyte; at least one electrode including: a gas permeable material; a second material; a spacer layer positioned between the gas permeable material and the second material, the spacer layer providing a gas collection layer; and, a conducting layer.

In another form there is provided a water splitting device, comprising: at least one cathode including: a first gas permeable material and a first conducting layer associated with the first gas permeable material; a second gas permeable material and a second conducting layer associated with the second gas permeable material; a spacer layer positioned between the first gas permeable material and the second gas permeable material, the spacer layer providing a gas collection layer; and, at least one anode including: a third gas permeable material and a third conducting layer associated with the third gas permeable material; a fourth gas permeable material and a fourth conducting layer associated with the fourth gas permeable material; a further spacer layer positioned between the third gas permeable material and the fourth gas permeable material, the further spacer layer providing a gas collection layer; wherein the at least one cathode and the at least one anode are at least partially within an electrolyte in operation.

In one example, the at least one electrode is a gas permeable electrode comprising two gas permeable materials having the spacer layer positioned between the materials and against an inner side of each material, and wherein each material includes a conducting layer on the outer side of each material. In another example, there is provided a plurality of cathodes and anodes interleaved with water permeable spacers defining electrolyte layers. In an example aspect the electrolyte is in fluid communication and connected to an electrolyte inlet and an electrolyte outlet, and the gas collection layer is in gaseous communication to a gas outlet.

In various other examples, there are provided methods for treating water comprising applying a low current density to the water splitting device, including: producing hydrogen gas and collecting the hydrogen gas via the gas collection layer; and/or pressurising the electrolyte. In other examples, the low current density is less than 1000 mA/cm²; the low current density is less than 100 mA/cm²; the low current density is less than 20 mA/cm²; producing hydrogen gas is at 75% energy efficiency HHV or greater; and/or producing hydrogen gas is at 85% energy efficiency HHV or greater.

In one form, there is provided a gas permeable electrode for a water splitting device comprising at least one gas permeable material and a spacer layer positioned against, adjacent or forming part of, an inner side of the material and between the material and another layer, said spacer layer defining a gas collection layer, and wherein the material includes a conducting layer. Optionally, the conducting layer includes or is associated with one or more catalysts, and wherein the conducting layer is on the outer side of the material.

In another form, there is provided a gas permeable electrode assembly for a water splitting device comprising two gas permeable materials having a spacer layer positioned between the materials and against, adjacent or forming part of, an inner side of each material, said spacer layer defining a gas collection layer and wherein each material includes a conducting layer. Optionally, one or both conducting layers include one or more catalysts, and wherein the conducting layer is on the outer side of each material.

In one example embodiment, the gas permeable material includes PTFE, polyethylene or polypropylene, or a combination thereof. In another example embodiment, at least a portion of the conducting layer is disposed between the catalyst and the material. Preferably, the gas permeable material is gas permeable and electrolyte impermeable. In another example embodiment, there is provided a gas permeable electrode wherein the spacer layer is in the form of a gas channel spacer or embossed structures positioned, attached, incorporated or placed on, near or at least partially within, an inner side of at least one of the gas permeable materials.

In another example form, the gas permeable electrodes can be interleaved with water permeable spacers to produce a multi-layered water splitting cell. An advantage of these electrodes is that they sandwich a gas collection layer between two gas permeable electrodes and may provide a cheap way of manufacturing a multi-layered water splitting cell.

In another example embodiment, there is provided a water splitting device comprising at least one cathode and at least one anode, wherein at least one of the least one cathode and at least one anode is a gas permeable electrode assembly comprising two gas permeable materials having a spacer layer positioned between or intermediate the materials and against, adjacent, or at least partially within, an inner side of each material, said spacer layer defining a gas collection layer, and wherein each material includes or is associated with a conducting layer. Optionally, the conducting layer includes one or more catalysts, and wherein the conducting layer is on the outer side of each material.

In another example embodiment, there is provided a water splitting device comprising a plurality of cathodes and anodes interleaved with water permeable spacers defining electrolyte layers, wherein the cathodes and the anodes are in the form of a gas permeable electrodes assembly comprising two gas permeable materials having a spacer layer positioned between or intermediate the materials and against, or at least partially within, an inner side of each material, said spacer layer defining a gas collection layer, and wherein each material includes a conducting layer. Optionally, the conducting layer includes one or more catalysts, and wherein the conducting layer is on the outer side of each material.

In further example forms, the water splitting devices may be configured into modular devices in which the footprint and gas handling infrastructure may be reduced. In one example embodiment, there is provided a water splitting device comprising a spiral wound multi-layered water splitting cell. In a further example, the water splitting cell includes a plurality of cathodes and anodes interleaved with water permeable spacers defining electrolyte layers, and wherein the cathodes and the anodes are in the form of gas permeable electrode assemblies comprising two gas permeable materials having a spacer layer positioned between or intermediate the gas permeable materials and against, or at least partially within, an inner side of each material, said spacer layer defining a gas collection layer, and wherein each material includes a conducting layer that includes at least one catalyst, and wherein the conducting layer is on the outer side of each material, said electrolyte in fluid communication and connected to an electrolyte inlet and an electrolyte outlet, said gas collection layer between the anodes in fluid communication to an oxygen outlet and said gas collection layer between the cathodes in fluid communication to a hydrogen outlet. The spiral wound water splitting device is a practical example way to reduce the footprint and gas handling infrastructure. Spiral wound devices permit the electrolyte to permeate through electrolyte layers along the water splitting device. The gases can be extracted laterally, for example oxygen in one direction to a collection channel and hydrogen in the other direction to another collection channel.

The example spiral wound water splitting device allows the cell to be manufactured from inexpensive and thin materials. A key advantage of employing inexpensive manufacturing techniques to produce water splitting cells, is that it makes it commercially viable to build cells with large surface areas and operate them at low current densities. These example water splitting cells are flexible and can be configured into a spiral wound water splitting device.

According to further example forms, in order to form spiral wound water splitting devices a multi-layered arrangement of flat-sheet materials may be rolled up into a spiral-wound arrangement. The spiral wound arrangement may then be encased in a casing, which holds the spiral-wound element in place within a module whilst allowing for water to transit through the module. Collection tubes may be positioned to plumb the respective gases, hydrogen and oxygen from the water splitting device. Conveniently, the collection tubes may be attached to the water splitting device with the desired collection channels being open to the collection tube for the respective gas. For example, all of the hydrogen gas channels may be open at a matching location and communicate with the collection tube for the hydrogen gas. At that location, the oxygen gas channels can be closed or sealed. At a different location on the water splitting cell, the oxygen gas channels may be open and communicate with the collection tube for the oxygen gas. At that location the hydrogen gas channels can be closed or sealed.

In another example embodiment, there is provided a water splitting device comprising a plurality of hollow fibre cathodes and a plurality of hollow fibre anodes, wherein said plurality of hollow fibre cathodes comprise a hollow fibre gas permeable material having a conducting layer that may include a catalyst, and wherein said plurality of hollow fibre anodes comprise a hollow fibre gas permeable material having a conducting layer that may include a catalyst.

One of the advantages addressed by example embodiments is the elimination of the need for a proton exchange membrane between the electrodes, as used in known water splitting cells. Proton exchange membranes are generally not required where gas permeable or breathable (preferably “bubble-free” or “substantially bubble-free”) electrodes are employed. Moreover, proton exchange membranes swell in aqueous media and, as a result, make it difficult to provide the packing efficiencies and modular designs desirable to produce water splitting cells having low capital expenditure requirements and low operating costs.

The inventors have found that the water splitting cells allow the efficient use of space between the anode and cathode. In one example, the water splitting cells permit at least 70% of the volume between the anode and the cathode to the occupied by electrolyte whilst maintaining the anode and cathode in a spaced apart relationship. In addition, the water splitting cells may allow a non-electrolyte component (e.g. the spacer layer) in the electrolyte chamber to be less than 20% of the total resistance of the electrolyte chamber. The water splitting cells may also permit the diffusion of both cations and anions across the electrolyte chamber without impedance, which would otherwise occur with use of a proton exchange membrane diaphragm.

In one example embodiment, the spacer layer or component within the electrolyte chamber may be gas permeable. In addition to use in water splitting cells, various example embodiments may be useful in performing other gas-to-liquid or liquid-to-gas transformations, such as fuel cells or water treatment devices. Various example forms address the pressing need for electrochemical cells capable of performing gas-to-liquid or liquid-to-gas transformations with high energy efficiencies. Specifically, various example forms address the need for an electrolyser capable of manufacturing hydrogen from water at high energy efficiency and low cost.

The inventors have realised or implemented one or more of the following example aspects, features or advantages, thus providing various example embodiments:
(1) when optimally fabricated and implemented, gas permeable or breathable electrode structures diminish the overall energy losses arising in a water electrolyser from the bubble overpotential. The effect of reducing or eliminating the bubble overpotential is to increase the overall energy efficiency of the water electrolysis process. The gas permeable or breathable electrode structures may be formed from a variety of gas permeable materials. In one form, the gas permeable materials may be porous, allowing the gases to migrate across the material through its porous structure. In another form, the gas permeable material may allow the gas to diffuse through a non-porous structure.
(2) low-cost catalysts containing earth-abundant elements can be used to catalyse the water-splitting reactions at the anode and cathode in gas permeable or breathable electrode structures. While such catalysts are often not amenable to energy efficient operation at high current densities, they are capable of achieving exceedingly high energy efficiencies at lower current densities than are currently used in commercial water electrolysers. Some catalysts are electrically conductive and in some embodiments, the catalyst may be used to form the conducting layer. An example of a electrically conducting material that is suitable for use as a catalyst is nickel.
(3) commercially-available and low-cost materials and material structures can be economically applied to the fabrication of gas permeable or breathable electrode structures which split water with high energy efficiency.
(4) reactor structures can be used to fabricate modular, multi-layer water electrolysis cells having exceedingly large internal surface areas, but relatively small external footprints and low overall costs. The effect of this realisation is to make it possible to build inexpensive, modular water electrolysis cells having high internal surface area but low external footprint.
(5) the availability of low-cost catalysts and materials, as well as low-cost reactor configurations with high internal surface areas, makes it possible to fabricate an entirely new type of electrolyser that generates hydrogen at low-cost and high energy efficiency by operating at lower current densities than has hitherto been commercially viable.

In various example forms, the high energy efficiency is achieved by one or more of: (a) low current density, which minimises the electrical losses, (b) low-cost catalysts, for example Earth-abundant elements which operate highly efficiently at lower current densities, and (c) the use of gas permeable or breathable electrode or material structures, which reduce or eliminate the bubble overpotential at each electrode.

In various example forms, the low cost is achieved by one or more of the following features within the electrolyser: (i) low-cost materials as the substrate for the gas permeable or breathable anodes and/or cathodes, (ii) low-cost catalysts, for example Earth-abundant elements, as the catalysts at the anode and cathode (instead of high-cost precious metals), and (iii) low-cost reactor structures that have relatively high internal surface areas but relatively small external footprints. Preferably, the combination of these factors allows for relatively high overall rates of gas generation even when relatively small current densities per unit surface area are employed.

In further example forms, the anodes and cathodes may comprise hollow flat-sheets or tubes whose external surfaces are porous and either hydrophobic (in the case where the liquid used is hydrophilic—e.g. water) or hydrophilic (in the case where the liquid used is hydrophobic —e.g. petroleum ether), to thereby allow the gases but not the liquids, or other electrolyte fluids, to pass through them into the associated gas channels.

### BRIEF DESCRIPTION OF THE DRAWINGS

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIGS. 1A-C graphically depict the performance of example water electrolysers containing at each of the anode and the cathode: FIG. 1A—Ni-coated flat-sheet breathable electrode in 1 M NaOH (without formation of bubbles or substantial formation of bubbles at the electrode), or

FIG. 1B—Pt-coated flat-sheet breathable electrodes in 1 M strong acid (without formation of bubbles or substantial formation of bubbles at the electrode), relative to FIG. 1C—an electrolyser comprising of known solid Pt flat-sheet electrodes in 1 M strong acid at the anode and cathode (with formation of bubbles).

FIGS. 2A-B graphically depict the performance of example water electrolysers containing at each of the anode and the cathode: FIG. 2A—Pt-coated hollow-fibre breathable electrodes (sealed at the bottom and open at the top) in 1 M strong acid (without formation of bubbles or substantial formation of bubbles at the electrode), relative to FIG. 2B—an electrolyser comprising of known solid Pt wire electrodes in 1 M strong acid at the anode and cathode (with formation of bubbles).

FIG. 3A-B depict: FIG. 3A—a perspective view of the example cell used to perform the measurements in FIGS. 1A-C; FIG. 3B—a cross-sectional schematic of the structure of the example cell.

FIGS. 4A-B depict: FIG. 4A—a photograph of a water electrolysis experiment containing a known standard Pt wire at one electrode (with bubbles clearly visible) and an example Pt-coated hollow-fibre (i.e. an example gas permeable electrode) (sealed at the bottom, open at the top) at the other electrode, with no bubbles visible; FIG. 4B—a schematic explaining the fabrication of example gas permeable electrodes with Pt-coated hollow-fibres for use in an example water splitting cell.

FIG. 5 depicts electron microscope pictures of the surface of the example Pt-coated hollow-fibre electrode of FIGS. 4A-B.

FIGS. 6A-B depicts: FIG. 6A—a schematic explaining the fabrication of example hollow-sheet gas permeable or breathable electrodes for an anode and cathode in an example electrolyser; FIG. 6B—an electron micrograph of a dense and robust example spacer (also referred to as a “permeate” or “gas-transport” spacer or spacer layer) that can be incorporated within a hollow space inside or between a rolled gas permeable material or gas permeable sheet materials.

FIG. 7 depicts an electron micrograph of the “flow-channel” example.

FIGS. 8A-C depict schematically an example process or method by which example electrodes can be formed for use as spiral-wound or flat electrodes in an electrolyser.

FIGS. 9A-E depict schematically: FIG. 9A—an example electrolyser or cell having flat-sheet electrodes; FIG. 9B and FIG. 9C—example electrolysers or cells having a spiral-wound electrode; FIG. 9D and FIG. 9E example electrical connections for a unipolar design and a bipolar design.

FIGS. 10A-C depict schematically an example process or method by which further example electrodes can be formed for use as spiral-wound or flat electrodes in an electrolyser.

FIGS. 11A-C depict schematically FIG. 11A—a further example electrolyser or cell having flat-sheet electrodes; FIG. 11B and FIG. 11C—further example electrolysers or cells having spiral-wound electrodes; using the example electrodes of FIGS. 10A-C.

FIG. 12 depicts a cut-away view of an example electrolyser module containing hollow-fibre gas permeable or breathable materials.

FIG. 13 is a schematic illustration of the operation of one type of example electrolyser module involving hollow-fibre gas permeable or breathable materials.

FIG. 14 is a schematic illustration the operation of a second type of example electrolyser module involving hollow-fibre gas permeable or breathable materials.

FIG. 15 is a schematic illustration showing how separate modules of an example spiral wound electrolyser may be combined within a second, tube housing to generate a larger quantity of hydrogen from water.

FIG. 16 illustrates how separate tube housings containing multiple modules may be combined within a plant.

FIG. 17 illustrates an example circuit for converting three-phase AC electricity into DC electricity with near-100% energy efficiency, for use with example electrolysers.

FIGS. 18A-D illustrates FIG. 18A—in an exploded view, and FIG. 18B—in an assembled view, how single, flat-sheet gas permeable or breathable material electrodes may be combined into an example ‘Plate-and-Frame’ style electrolyser. FIGS. 18C-D illustrate how two such example anode-cathode cells may be combined into an example multi-layer electrolyser.

FIGS. 19A-C depict typical rates of gas generation by the example ‘plate-and-frame’ style electrolyser from FIGS. 18A-D, over three days of operation under conditions of constant switching “on” and “off”. FIG. 19A depicts data for part of day 1; FIG. 19B depicts data for part of day 2; and FIG. 19C depicts data for part of day 3.

### EXAMPLES

The following modes, features or aspects, given by way of example only, are described in order to provide a more precise understanding of the subject matter of a preferred embodiment or embodiments. In the figures, incorporated to illustrate features of example embodiments, like reference numerals are used to identify like parts throughout the figures.

Example gas permeable or breathable electrodes may be formed by any convenient means. For example, gas permeable electrodes can be formed by depositing a conducting layer on a gas permeable material and subsequently depositing a catalyst on the conducting layer. In one example, one could start with a gas permeable non-conducting material and then form the conducting layer on the material, and thereafter, deposit the catalyst. Alternatively, one could start with a gas permeable conducting material and then deposit the catalyst.

In another example, a gas permeable or breathable electrode may be formed by holding or positioning a conductive layer, incorporating a catalyst or not, in close association with a gas permeable or breathable material. In this example, one would form the conducting layer with catalyst separately and then position, place or attach the conducting layer against a gas permeable material. The inventors have found that by simply pressing the conducting layer against a gas permeable material one is able to have a significant proportion of gas reaction products to migrate across the material and not form bubbles, or not substantially form bubbles or at least visible bubbles, in the electrolyte. The conducting layer with catalyst may be chemically or physically bound to the gas permeable material.

The anode and cathode layers may be separated by suitable liquid-permeable, electrically-insulating spacers, which allow liquid ingress to the anodes and cathodes whilst simultaneously preventing short circuits from forming between the anodes and cathodes. One example of such a spacer is the “feed-channel” spacers used in commercially-available reverse osmosis membrane modules. The spacer is suitably robust to allow the transit of liquids but prevent the anodes and cathodes from collapsing on themselves, even under high applied pressures.

In one example there is provided an electrode for a water splitting device. The electrode comprises a gas permeable material and a second material, being part of the electrode, and/or an anode or a cathode adjacent to the electrode. A spacer layer is positioned between the gas permeable material and the second material, the spacer layer providing a gas collection layer, i.e. within the electrode or between the electrode and an adjacent anode or cathode. A conducting layer is also provided as part of the electrode and is associated with the gas permeable material. The second material may be part of the electrode or an adjacent electrode (e.g. anode-anode, cathode-cathode or anode-cathode pairs), and in a preferred example is also a gas permeable or breathable material. The conducting layer can be provided adjacent to or at least partially within the gas permeable material, preferably on an outer side of the gas permeable material. Preferably, the conducting layer is associated with, positioned next to or is deposited on the gas permeable material. The gas collection layer is able to transport gas internally in the electrode, preferably to an exit area or region of the electrode. In another example, the gas permeable material is a gas permeable membrane and the second material is a further or additional gas permeable membrane.

Preferably, the gas collection layer is able to transport gas internally in the electrode to at least one gas exit area positioned at or near an edge or an end of the electrode. In another example the gas permeable material and the second material are separate layers of the electrode. The second material is preferably a gas permeable material or membrane. The second material can be a gas permeable material and a second conducting layer can be provided adjacent to or at least partially within the second material. Thus, in one example the spacer layer providing a gas collection layer is provided or positioned between a gas permeable layer and a second layer (i.e. the second material) being a further gas permeable layer of the electrode. In another example, the second material is a gas permeable material and a second conducting layer is associated with, positioned adjacent to, or deposited on the second material.

Spacer layers are provided to maintain the respective gas collection channels as well as the electrolyte channels. Suitable spacer layers can be selected for each channel. The gas collection layer in the respective electrodes is maintained by a spacer layer which may be in the form of embossed structures on the inner surfaces of the materials or as a separate spacer device such as a gas diffusion spacer or the like. The electrolyte layer between the anodes and cathodes may be maintained by the use of a spacer layer in the form of a “flow channel” spacer. Other suitable spaces may be used that allow the electrolyte to permeate the electrolyte layer and contact the respective anode and cathodes.

The internal vacancies, voids or spaces within the hollow sheets or fibres comprising the anodes and cathodes, may be filled, or at least partially filled, with a spacer or spacer layer, preferably a robust spacer or spacer layer, that allows gases to pass through the spacer or spacer layer, but which prevents the walls of the hollow structure from collapsing on themselves, even under high applied pressures. An example of such a spacer is the “permeate” spacer used in commercially-available reverse osmosis membrane modules.

The gas permeable or breathable anodes and cathodes may be constructed by depositing electrically conductive metallic layers on an outer surface or surfaces of the gas permeable or breathable materials and then, if necessary, depositing suitable (electro)catalysts on the electrically conductive layers. Alternatively, the electrically conductive metallic layers may serve as (electro)catalysts in their own right. The catalysts may be so chosen as to facilitate and accelerate the liquid-to-gas or gas-to-liquid transformation.

The gas permeable or breathable electrodes may be conveniently constructed whereby the gas flux across the gas permeable material is tuned to the production rate of the reaction product that may form a gas at the electrode. In an alternative example, the gas permeable or breathable anodes and cathodes are constructed by co-assembling in close and tight-fit proximity to each other: (1) a gas permeable or breathable material with (2) a free-standing, planar, porous metallic or conductive structure coated, where necessary, with suitable catalysts. The free-standing, planar, porous conductive structures may be fine metal meshes, grids, felts, or similar planar, porous conductors. Conductive structures of this type are commercially available from a wide variety of vendors.

The gas permeable or breathable materials maintain a well-defined liquid-gas interface at all of the anodes and cathodes in the cell during the reaction. This may be achieved by ensuring that the differential pressure across the gas permeable or breathable materials of the anodes and cathodes (from the liquid side to the gas side) is less than the capillary pressure to wet their pores. In this way, liquid is not driven into the gas channels nor gas driven into the liquid chambers, as a result of the applied pressure.

In liquid-to-gas or gas-to-liquid transformations in which a pressure larger than atmospheric is applied to either the liquid or the gases, the reactor may be designed so that the applied pressure does not exceed the capillary pressure at which liquid is driven into the gas channels or gas driven into the liquid channels. That is, the pores of the materials are so chosen as to ensure the maintenance of a distinct liquid-gas interface at the anodes and cathodes during operation under the applied pressure.

Washburn's equation is used to calculate the maximum pore size required to maintain a clear liquid-gas interface at the gas permeable or breathable electrodes when a pressure is applied to either the gases or the liquids in the reactor, as described in the non-limiting case in example 5. In the non-limiting case of PTFE materials with water as an electrolyte in a water electrolyser, where the contact angle is 115° and a 1 bar pressure differential is applied across the material, the pores should preferably have a radius or other characteristic dimension of less than 0.5 microns, more preferably less than 0.25 microns, and still more preferably about 0.1 microns or lower. In the case where the contact angle is 100°, the pores should preferably have a radius or other characteristic dimension of less than 0.1 microns, more preferably less than 0.05 microns, and still more preferably about 0.025 microns or lower.

The materials used to fabricate the gas permeable or breathable anodes and cathodes in one example swell by less than 1% in water, or in the liquid employed in the device. The gases associated with the anodes and cathodes are kept separate from each other by engineering the gas channels within the reactor such that the anode gases are separated at all points from the cathode gases. In another example, the multi-layered structure of anodes and cathodes comprising the electrochemical cell is housed within a tight-fitting and robust casing which holds within it, all of the anodes and cathodes, as well as the gas and liquid channels. That is, the multi-layered structure of anodes and cathodes and their associated gas and liquid channels are fabricated in a modular form, which maybe readily linked to other modules to form larger overall reactor structures. Moreover, in the case of failure, they may be readily removed from and replaced in such structures by other identically constructed modules.

In another example, the multi-layered structures of anodes and cathodes within a single module have a relatively high internal surfaces area, but a relatively low external area or footprint. For example, a single module may have an internal structure of more than 2 square meters, but external dimensions of 1 square meter. In another example, a single module could have an internal area of more than 10 square meters, but external area of less than 1 square meter. A single module may have an internal area of more than 20 square meters, but an external area of less than 1 square meter. In another example, the multi-layered structure of anodes within a single module, may have the gas channels associated with the anode connected into a single inlet/outlet pipe.

In another example, the multi-layered structure of cathodes within a single module, may have the gas channels associated with the cathode connected into a single inlet/outlet pipe, which is separate from the anode inlet/outlet pipe. In a further example, the multi-layered structure of anodes and cathodes within a single module may be configured as a multi-layered material arrangement. The multi-layer spiral wound structure may comprise one or more than one cathode/anode electrode assembly pairs, and may comprise one or more leaf assemblies.

The modular units described above may be so engineered as to be readily attached to other, identical modular units, to thereby seamlessly enlarge the overall reactor to the extent required. The combined modular units as described above may themselves be housed within a second, robust housing that contains within it all of the liquid that is passed through the modular units and which serves as a second containment chamber for the gases that are present within the interconnected modules. The individual modular units within the second, outer robust housing may be readily and easily removed and exchanged for other, identical modules, allowing easy replacement of defective or poorly operational modules.

An example water splitting cell may be operated at relatively low current densities in order to achieve high energy efficiencies in the production of gases—from liquids, or liquids-from-gases. The water splitting cells may be operated at a current density that accords with the highest reasonable energy efficiency under the circumstances. For example, in the case of a reactor which converts water into hydrogen and oxygen gas (a water electrolyser), the reactor may be operated at a current density that accords with more than 75% energy efficiency in terms of the higher heating value (HHV) of hydrogen. As 1 kg of hydrogen contains within it a total of 39 kWh of energy, 75% energy efficiency may be achieved if the electrolyser generates 1 kg of hydrogen upon the application of 52 kWh of electrical energy.

The water electrolyser may be operated at a current density that accords with more than 85% energy efficiency according to the higher heating value (HHV) of hydrogen; 85% energy efficiency may be achieved if the electrolyser generates 1 kg of hydrogen upon the application of 45.9 kWh of electrical energy. The water splitting cell may be operated at a current density that accords with more than 90% energy efficiency according to the higher heating value (HHV) of hydrogen; 90% energy efficiency may be achieved if the electrolyser generates 1 kg of hydrogen upon the application of 43.3 kWh of electrical energy. The removal of produced gas across the gas permeable material results in a device capable of, separating the gas from the reaction at the electrode. Greater than 90% of the gas produced at the at least one electrode can be removed from the cell across the gas permeable material. Desirably, greater than 95% and greater than 99% of the gas produced can be removed across the gas permeable material. The water splitting cell may operate to produce hydrogen gas at greater than 75% energy efficiency HHV. Desirably, the water splitting cell may produce hydrogen gas at greater than 90% energy efficiency HHV.

The inventors have found that the water splitting cells may be operated efficiently by managing the pressure differential across the gas permeable materials. The management of the pressure differential may prevent wetting of the materials and drives the gas reaction products across the material. The selection of pressure differential will be typically dependent upon the nature of the water splitting materials and may be determined with reference to Washburn's equation as described below. Pressurising the electrolyte may also be useful in providing a pressurised gas product in the gas collection layers.

In another example there is provided a process for generating hydrogen comprising applying low current density to a water splitting cell pressurising an electrolyte, splitting water and producing hydrogen gas and oxygen gas; and collecting the respective pressurised gases with the respective gas collection layers. The water splitting cell may be operated at temperatures that are desirably less than 100° C., less than 75° C. and less than 50° C.

The individual electrochemical cells within the reactor may be so configured in series or parallel, as to maximize the voltage (Volts) and minimise the current (Amps) required. This is because, in general, the cost of electrical conductors increases as the current load increases, whereas the cost of AC-DC rectification equipment per unit output decreases as the output voltage increases. The overall configuration of the individual cells in series or parallel within the reactor may be configured as to best match the available three-phase industrial or residential power. This is because a close match of the overall power requirements of the electrolyser and the available three-phase power generally allows for low-cost AC to DC conversion with near 100% energy efficiency, thereby minimising losses.

A preferred embodiment typically includes an electrochemical reactor for direct electrical transformation of water into hydrogen and oxygen, the water electrolyser preferably but not exclusively, comprising hollow gas permeable or breathable electrode structures (e.g. flat-sheets or fibres) as anodes and cathodes in multi-layered arrangements:
i. where the anodes have associated with them discrete oxygen gas channels,
ii. where the cathodes have associated with them discrete hydrogen gas channels,
iii. each of which hydrogen or oxygen channels are linked to their respective electrodes by the pores in the gas permeable or breathable materials,
iv. where the gas permeable or breathable materials maintain a distinct liquid-gas interface during the reaction,
v. where the pore sizes and qualities of the gas permeable or breathable materials are such that they maintain distinct liquid-gas interfaces under conditions where the liquids and/or gases are subjected to an applied pressure greater than atmospheric during operation,
vi. where the spaces between the anodes and cathodes are occupied by robust electrically insulating spacers (“feed-channel spacers”) that allow the ingress of electrolyte water to the anodes and cathodes, whilst preventing the anodes and cathodes from contacting each other and thereby forming short circuits,
vii. where the gas channels are preferably, but not exclusively, occupied by robust spacers (“gas-channel spacers”) that allow for the transport of gases through them but prevent the walls of the gas channels from falling in upon themselves even in circumstances where a pressure larger than atmospheric is applied to the water electrolyte, viii. where the hydrogen gas channels are linked to a single hydrogen gas outlet,
ix. where the oxygen gas channels are linked to a single oxygen gas outlet,
x. where the water is allowed to permeate between the anodes and cathodes,
xi. where the entire multi-layered arrangement of anodes, cathodes, spacers and gas channels, is incorporated within a single module having relatively high internal surface area but low external footprint,
xii. where the modular units can be readily attached to other, identical modular units, to thereby seamlessly enlarge the electrolyser to the extent required,
xiii. where the combined modular units are themselves housed within a second, robust housing that contains within it all of the water that is passed through the modular units and which serves as a second containment shield for the flammable hydrogen gas that is generated within the modules,
xiv. where individual modular units within the second housing can be readily and easily exchanged for other, identical modules,
xv. where the electrolyser is operated at low overall current density in order to achieve high energy efficiencies in the production of hydrogen gas from water; preferably at a current density according with 75% energy efficiency, or, more preferably, at 85% energy efficiency, or still more preferably at more than 90% energy efficiency,
xvi. where the individual cells within the overall electrolyser assembly are so configured in series or parallel as to generally maximize the voltage (Volts) and minimise the current (Amps) required, and/or
xvii. where the individual cells within the overall electrolyser assembly are so configured in series or parallel as to best match the available three-phase industrial or residential power.

### Example 1: Demonstration of the Potential of Gas Permeable or Breathable Electrodes to Achieve High Energy Efficiencies in Water Electrolysis

To assess whether the use of gas permeable or breathable electrodes could improve the energy efficiency of the liquid-to-gas transformation that occurs in water electrolysers, we examined the optimal fabrication of gas permeable or breathable electrodes. The gas permeable or breathable electrodes were then tested by incorporation in bubble-free, laboratory-scale water electrolysers where their performance was compared under optimum conditions of acidity/basicity with standard, industry-best catalysts which generated bubbles. For this comparison we selected solid platinum (Pt) in 1 M strong acid as the “industry-best” catalyst. The reason for this choice was that the other alternative—namely, nickel (Ni) catalyst in strongly basic alkaline electrolysers—is generally considered less energy efficient overall than Pt in strong acid.

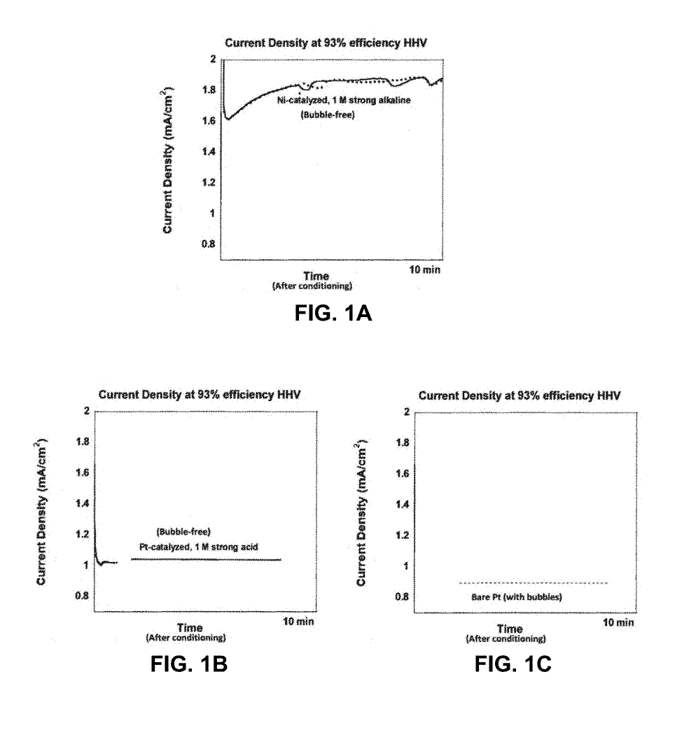

All of the comparisons involved the use of very simply deposited, smooth metals with low surface area. The idea was to see how they compare in their efficiency and overall output, and whether the use of gas permeable or breathable electrodes could improve the overall energy efficiency of water electrolysis compared to the best available industry catalysts. The data in FIGS. 1A-C-2A-B compares typical performances of the various bubble-free electrolysers with the industry-best Pt catalyst in 1 M strong acid, where bubbles are generated.

### Example 1A: Water Electrolysers Employing Flat-Sheet Gas Permeable or Breathable Electrodes

The first set of data displayed in FIGS. 1A-C examine two “bubble-free” electrolysers incorporating flat-sheet breathable electrodes at both the cathode and anode: a Ni-catalyzed alkaline electrolyser in 1 M strong base (FIG. 1A), and a Pt-catalyzed acid electrolyser in 1 M strong acid (FIG. 1B). The acid used was sulphuric acid. The base used was sodium hydroxide. The same catalysts were used at both of the anode and cathode simultaneously.

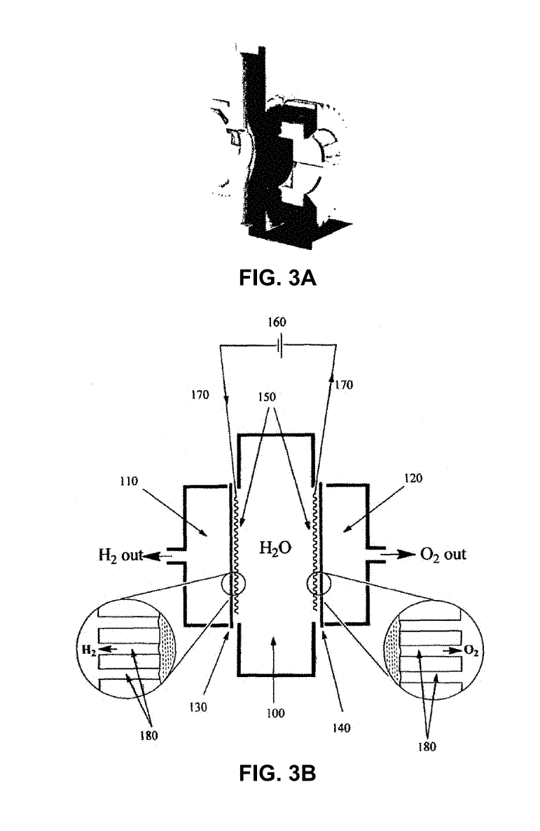

The data in FIGS. 1A-B was collected using the cell depicted in FIGS. 3A-B. The cell in FIG. 3A is depicted schematically in FIG. 3B. The cell comprises the following parts: a central water reservoir 100 has a water-free hydrogen collection chamber 110 on the left side and a water-free oxygen collection chamber 120 on the right side. Between the water reservoir 100 and the hydrogen collection chamber 110 is a gas permeable or breathable electrode 130. Between the water reservoir 100 and the oxygen collection chamber 120 is a gas permeable or breathable electrode 140. On, or close to, or partially within, the surface of the gas permeable or breathable electrodes 130 and 140 is a conductive layer containing a suitable catalyst 150, or more than one catalysts. When an electrical current is applied to the conductive layers 150 by an electrical power source 160, such as a battery, then electrons flow along the outer circuit as shown in circuit pathways 170. That current causes water to be split into hydrogen on the surface of the breathable electrode 130 (called the cathode) and oxygen on the surface of the breathable electrode 140 (called the anode). Instead of forming bubbles at these surfaces, the oxygen and hydrogen passes through the hydrophobic pores 180 into the oxygen and hydrogen collection chambers 120 and 110, respectively. Liquid water cannot pass through these pores since it repels the hydrophobic surfaces of the pores and the surface tension of the water prevents droplets of water from disengaging from the bulk of the water to thereby pass through the pores. Thus, the electrodes 130 and 140 act as gas-permeable, water-impermeable barriers.

For the data in FIG. 1A, the Ni catalyst was a commercially available, thin Ni-coated flexible textile, which is used for electromagnetic shielding. The textile was pushed and held tight against a gas permeable or breathable hydrophobic material. This worked just as well as depositing the metal directly onto the material surface as was done for the data in FIG. 1B), where the Pt catalyst was deposited directly on the material by vacuum metallization, a standard commercial process. In both cases, the catalysts were subjected to extended conditioning before the representative data shown in FIGS. 1A-B was collected. By this is meant that the electrolysers were left in operation in the 1 M strong acid/base conditions shown with an applied voltage (typically 2-3 V) for several hours before measuring the data. The conditioning allows the systems to get to a clear steady state and ensures that the measurements are reliable.

The current density at a fixed cell voltage of 1.6 V (=93% energy efficiency HHV) was then measured for the two bubble-free electrolysers. As can be seen, both of the breathable Ni and Pt systems gave current densities of 1 mA/cm² or more. The Pt one gave a stable current within 1 min of being switched on. The Ni one took about 5 min to reach a stable current. But both of the currents are over 1 mA/cm² and both are maintained unchanged for extended periods of time (data not shown in FIGS. 1A-C for clarity).

By comparison, and referring to FIG. 1C, the inventors have previously studied the “industry-best” Pt catalyst in 1 M strong acid with bubble formation. Those studies showed that, after conditioning for 1 h and under the most optimum possible conditions (more optimum than for the results in FIGS. 1A and B), solid bare Pt generates a steady-state current of, on average, 0.83 mA/cm². This is the absolute maximum steady-state current density one can get at a Pt cathode when using a very large Pt mesh electrode at the anode. If two equally-sized electrodes were used at the anode and cathode (as was the case in the data in FIGS. 1A-B), the current density would be lower.

By this measure both of the bubble-free electrolysers incorporating alkaline Ni-catalyzed and acid Pt-catalysed breathable cells at each of the anode and cathode convincingly beat simple electrolysers employing the industry-best catalyst, Pt, at both anode and cathode in a configuration where bubbles were generated. Moreover, the material-based electrolysers do not exhibit the usual jagged chronoamperogram profiles associated with bubble-formation, nor a slowly declining output until a steady-state is generated, as is found with bare Pt.

### Example 1B: Water Electrolysers Employing Hollow-Fibre Gas Permeable or Breathable Electrodes

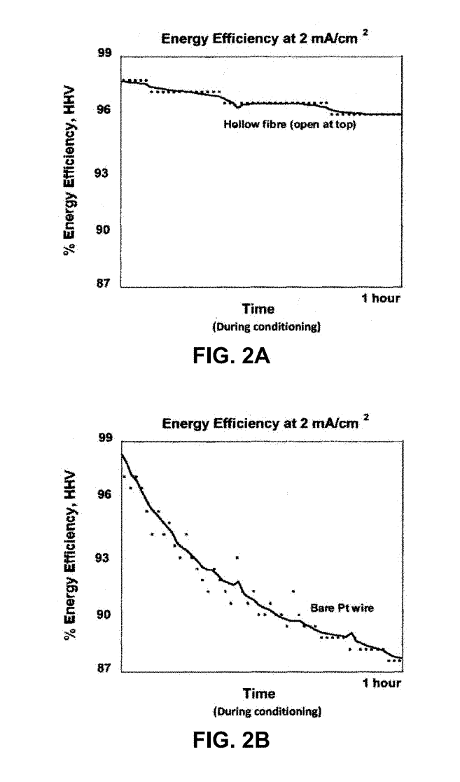

The second set of data in FIGS. 2A-B compare, under optimum conditions of acidity (1 M strong acid):
(1) a bubble-free electrolyser incorporating gas permeable or breathable hollow-fibre electrodes coated with Pt at both the anode and cathode (the Pt was deposited directly onto the materials using vacuum metallization, a standard commercial process), and
(2) The same electrolyser cell, but with known bare Pt wire electrodes at both anode and cathode.

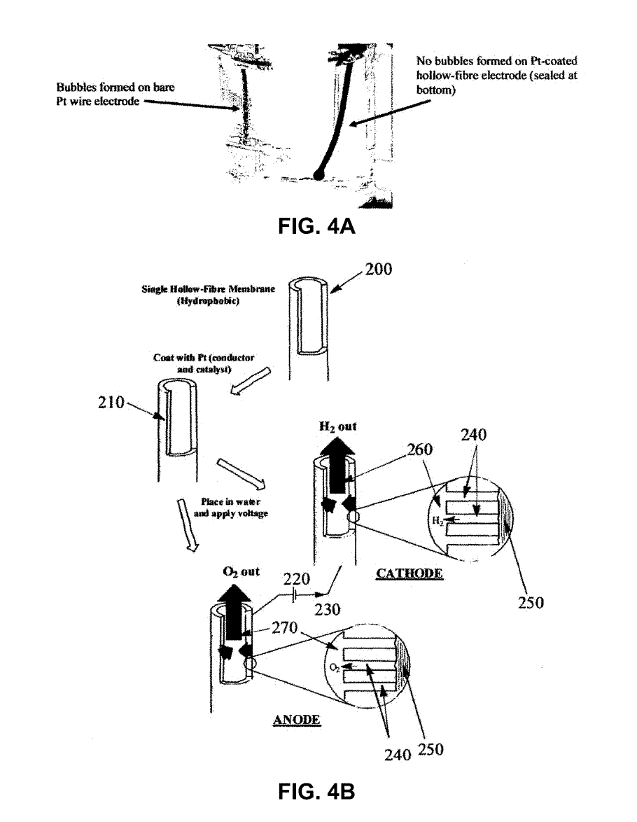

FIG. 4A depicts a photograph of an example electrolyser contrasting a known bare Pt wire for the cathode and a Pt-coated hydrophobic hollow-fibre gas permeable electrode for the anode. As can be seen, the known bare Pt wire becomes covered in bubbles during the water electrolysis, whereas the hollow-fibre gas permeable electrode is bubble free, i.e. without bubble formation or without substantial bubble formation, at least visible bubble formation.

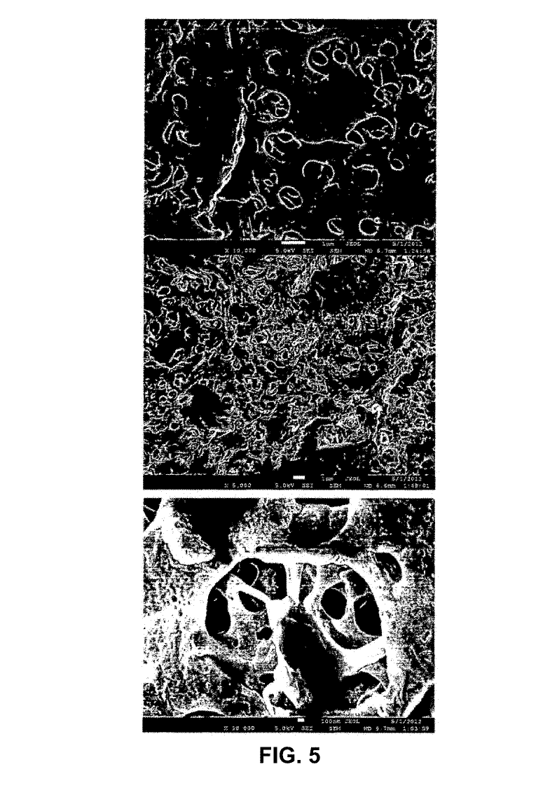

FIG. 4B depicts a schematic of a method or process by which the bubble-free electrolyser in point (1) above was fabricated and how it operates. Hydrophobic hollow-fibre materials 200 were obtained. These were then coated by vacuum metallization of Pt—a standard commercial process—to yield the Pt-coated hollow-fibre material 210. (FIG. 5 depicts a scanning electron micrograph of the surface of 210, showing the thickness of the coating to be 20-50 nm). Two Pt-coated hollow-fibre materials are then sealed at the bottom using araldite glue and dipped into an aqueous solution of 1 M strong acid. The open tops of the hollow-fibre materials are left to protrude above the surface of the liquid water. Electrical connections at their surfaces (on the conducting Pt) are connected to a power source, such as battery 220, which is used to drive an electrical current between the two, with the electron movement shown at conducting pathway 230. As a result of the applied voltage, water is split into hydrogen gas at the surface of the cathode and oxygen gas at the surface of the anode. The gases do not form bubbles however, as they instead transit through the hydrophobic pores of the hollow fibre gas permeable materials 240. Liquid water does not pass through these pores because under the atmospheric test conditions, liquid water is not capable of wetting the hydrophobic porous surface, in this example based on Goretex® material, a porous form of polytetrafluoroethylene (PTFE) with a micro-structure characterized by nodes interconnected by fibrils. Thus, hydrogen gas is collected in the hydrogen gas channel 260 within the center of the cathode hollow-fibre material. Oxygen gas is collected within the oxygen gas channel at the center of the anodic hollow-fibre.

The operation of the above example electrolyser yields the data shown in FIG. 2A. To obtain this data, we applied a fixed current density of 2 mA/cm² to the electrolyser and then examined how the voltage (energy efficiency) varied over time. The data is illustrated in this way to demonstrate how a commercial electrolyser of this type may be operated. The use of a fixed current density may be the most suitable mode of operation since it guarantees the generation of a particular quantity of hydrogen per day. (The rate of hydrogen generation is dependent on the current employed). The data in FIG. 2B shows comparable results with a known bare Pt wire at both the anode and cathode under otherwise identical conditions. In both cases, the catalysts were not pre-conditioned in order to demonstrate what happens during the first hour of operation of an electrolyser and to show why conditioning is necessary to obtain accurate data.

For the known bare Pt wire, one observes a clear decline in energy efficiency over an hour of conditioning; this is very typical of bare Pt electrodes and occurs before a steady-state is established (after 1-2 hours of operation). During the conditioning process, the energy efficiency can be seen to decline to around 88% (1 hour). One hour later it is typically around 85%, which is at or near to the steady state current density. The solid Pt electrodes have been previously studied by the inventors and yielded an energy efficiency of around the 83-85% mark at 2 mA/cm² after a steady-state was established. By contrast, the hollow-fibre gas permeable electrodes do not display a similar decline. Their chronovoltammetric profile is virtually flat, at around 96% energy efficiency, and with only relatively small declines to the steady-state. Moreover, they maintain higher energy efficiencies than the comparable known bare Pt wire “industry-best” catalysts over extended periods (e.g. 12 h of continuous testing). They are noticeably more energy efficient than the industry-best Pt catalyst in a configuration where bubbles are generated.

### Conclusions for Example 1: Electrolysers Comprising of Gas Permeable or Breathable Electrodes at Both Anode and Cathode May Achieve High Energy Efficiencies in Water Electrolysis

Thus, it can be concluded that bubble-free water electrolysers, i.e. that operate without substantial bubble formation, comprising of gas permeable or breathable electrodes at both the cathode and anode may achieve higher energy efficiencies than systems which generate bubbles in liquid-to-gas transformations. This is due to the reduction or elimination of the bubble overpotential, which comprises a major source of energy loss in such systems.

Furthermore, if this is true for water electrolysis, which is one of the most challenging electrochemical liquid-to-gas transformations, then it may also be true for other electrochemical liquid-to-gas transformations. Moreover, the stability of the gas-liquid interface in such systems will, likely, also greatly facilitate and improve the energy efficiency of comparable gas-to-liquid electrochemical transformations in such reactors.

### Example 2: An Electrochemical Reactor Comprising a Multi-Layer, Hollow Flat-Sheet Configuration (‘Spiral-Wound Module’)

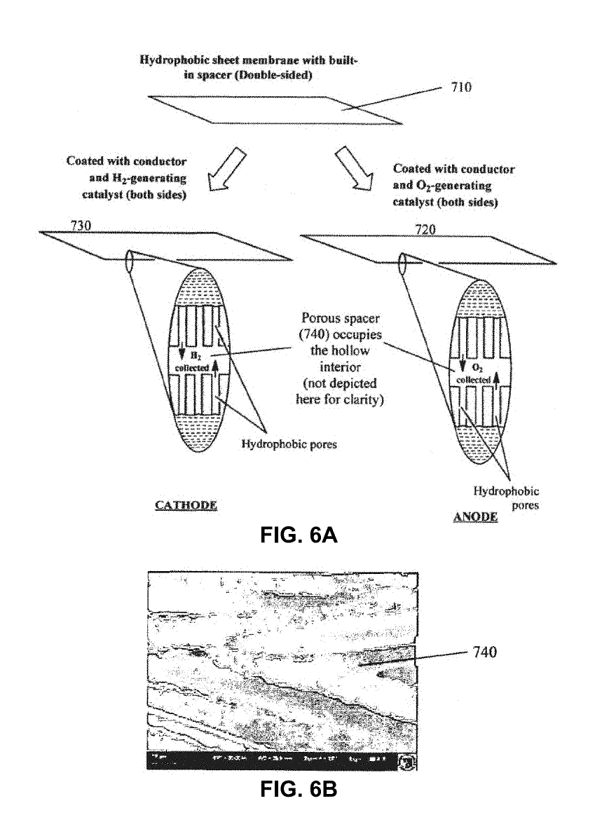

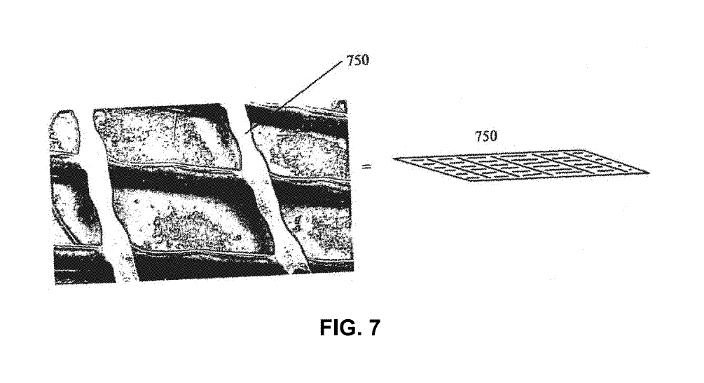

FIG. 6A schematically depicts a double-sided, flat-sheet hydrophobic material 710. The material comprises of an upper and a lower hydrophobic surface with a spacer, known generically as a “permeate” spacer 740 between them. The upper and lower surfaces contain hydrophobic pores which allow gases, but not liquid water to pass through unless sufficient pressure is applied and/or the water surface tension is sufficiently lowered. The “permeate” spacer is typically dense but porous. FIG. 6B illustrates a typical microscopic structure of this spacer. The microscopic structure of a “flow channel” spacer of this type is depicted in FIG. 7. As can be seen in FIG. 7, whereas this spacer has an open structure that is suitable for transport of water through it, the spacer in FIG. 6B has a more dense structure, making it suitable for gas, but not liquid transport. To construct a flat-sheet water electrolyser reactor, one can start with the hydrophobic double-sided material with built-in gas spacer 710. Upon the surface of this material a conductive layer is deposited, typically using vacuum metallization. In the case of an alkaline electrolyser, the conductive layer is typically nickel (Ni). Using this technique, Ni layers of 20-50 nm may be deposited. The Ni-coated materials may then be subjected to dip-coating using, for example, electroless nickel plating, to thicken the conducting Ni layer on their surface. After this, a catalyst, or more than one catalyst, may be deposited upon or otherwise attached to the conducting Ni surface. A range of possible catalysts exist and are known in the art.

For water oxidation (namely the reaction that occurs at the anode in water splitting), catalysts such as Co₃O₄, LiCo₂O₄, NiCo₂O₄, MnO₂, Mn₂O₃, and other catalysts are available. The catalyst may be deposited by various means known in the art. A representative example of depositing such a catalyst upon a nickel surface is given in the publication entitled: “Size-Dependent Activity of Co₃O₄Nanoparticle Anodes for Alkaline Water Electrolysis” by Arthur J. Esswein, Meredith J. McMurdo, Phillip N. Ross, Alexis T. Bell, and T. Don Tilley, in the Journal of Physical Chemistry C 2009, Volume 113, pages 15068-15072. By means such as these, the anode 720 in FIG. 6A may be prepared.

For the cathode, various catalysts exist that may be deposited on the nickel surface, such as nanoparticulate Ni or nanoparticulate nickel and other metal alloys. The publication entitled: “Pre-Investigation of Water Electrolysis”, document PSO-F&U 2006-1-6287, issued jointly by the Department of Chemistry, Technical University of Denmark, The Riso National Laboratory of Denmark and DONG Energy, in 2008, describes means to deposit such materials on the anode (starting from page 50). The cathode 730 in FIG. 6A. may thus be prepared. The document goes on to describe anode catalysts and means of depositing them on the anode.

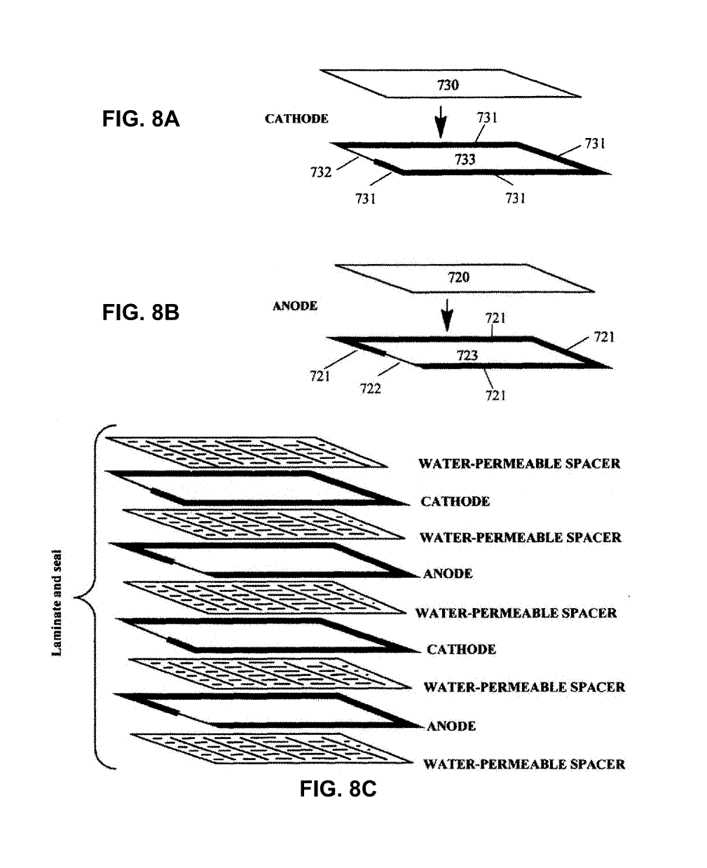

FIGS. 8A-C illustrate one approach to making an example water electrolyser using the hollow, flat sheet cathode 730 and anode 720, thus prepared. The cathode 730 is sealed 731 at three of the four edges, with the fourth edge half sealed 731 and half left unsealed 732 as shown. The sealing may be carried out by snap heating and melting the edges of the hollow flat-sheets to thereby block the movements of gases and liquids out of the edges. Laser heating may also be used to seal the edges of the cathode. The anode 720 is sealed 721 at three of the four edges, with the fourth edge half sealed 721 and half left unsealed 722 as shown. The sealing may be carried out by snap heating and melting the edges of the hollow flat-sheets to thereby block the movements of gases and liquids out of the edges. Laser heating may also be used to seal the edges of the anode. The sealing depicted in FIGS. 8A and 8B may be carried out before the deposition of the conducting Ni layer and deposition of the catalysts, if this is more suitable. As shown in FIG. 8C, the anodes and cathodes are then stacked with intervening flow-channel spacers of the type depicted in FIG. 7. Note that the unsealed edges of the anodes all line up with each other along the back left edge, whereas the unsealed edges of the cathodes line up with each other along the front left edge. Note that the unsealed edges of the anodes and cathodes do not overlap each other.

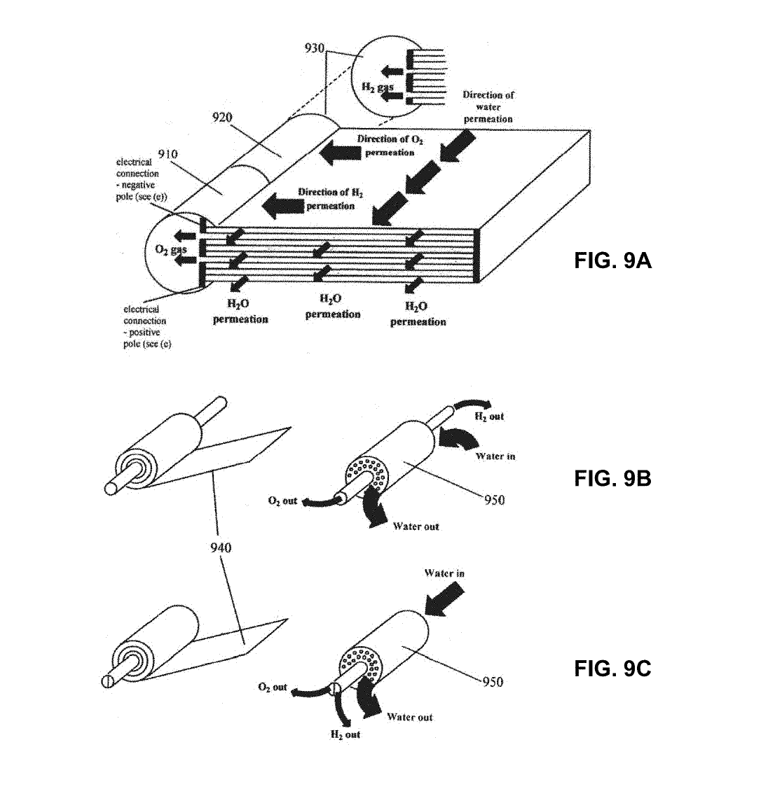

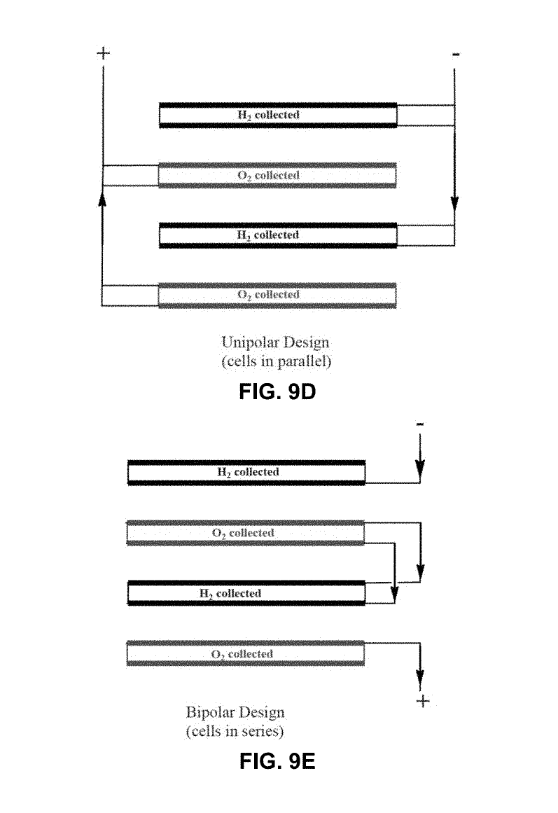

FIG. 9A depicts how the assembly in FIG. 8C may be turned into an example water electrolyser. A hollow tube (typically comprising of an electrically insulating polymer) is attached to the assembly in FIG. 8C, as shown in FIG. 9A. The tube is segregated into a forward chamber 910 and a rear chamber 920 which are not connected to each other. The anodes and cathode are attached to the tube in such a way that their unsealed edges open into the internal chambers of the tube. The unsealed edges of the cathode open exclusively into the rear chamber of the tube 920, while the unsealed edges of the anode open exclusively into the forward chamber of the tube 910. The anodes and cathodes may be electrically connected in series (bipolar design) or parallel (unipolar design), with a single external electrical connection for the positive pole and another single external electrical connection for the negative pole (as shown in FIG. 9A). FIGS. 9D-E depict possible, non-limiting connection pathways for a unipolar design (FIG. 9D) and a bipolar design (FIG. 9C). Other connection pathways are possible.

During operation of the electrolyser, water is allowed to permeate through the flow-channel spacers in the direction (out of the page) shown in FIG. 9A. Thus, during operation, water is present at and fills the intervening space between the anodes and cathodes. When a voltage is now applied across the anodes and cathodes, hydrogen is generated at the surface of the cathodes and passes through the pores of the cathode materials as depicted in FIG. 6A. Oxygen is simultaneously generated at the surface of the anodes and passes through the pores of the anode materials as depicted in FIG. 6A. The oxygen and hydrogen then fill the vacant space about the spacer within the hollow sheet anodes and cathodes. The only escape for the hydrogen is to exit the hollow sheet cathode by the unsealed edges into the rear chamber 920 of the attached tube. The only escape for the oxygen is to exit the hollow-sheet anodes by the unsealed edges into the forward chamber 910 of the attached tube. In this way, the gases are channeled and collected separately in the forward 910 and rear 920 chambers of the attached tube.

To minimise the overall footprint of the reactor, the multi-layered arrangement of flat-sheet materials may be rolled up into a spiral-wound arrangement as shown in 940 (FIG. 9B. The spiral wound arrangement may then be encased in a polymer casing 950, which holds the spiral-wound element in place within a module (950) whilst nevertheless allowing for water to transit through the module as shown in FIG. 9B. When a suitable voltage is applied to such a module, hydrogen gas is generated and exits the module at the rear tube as shown. Oxygen gas is generated at the forward tube as shown.

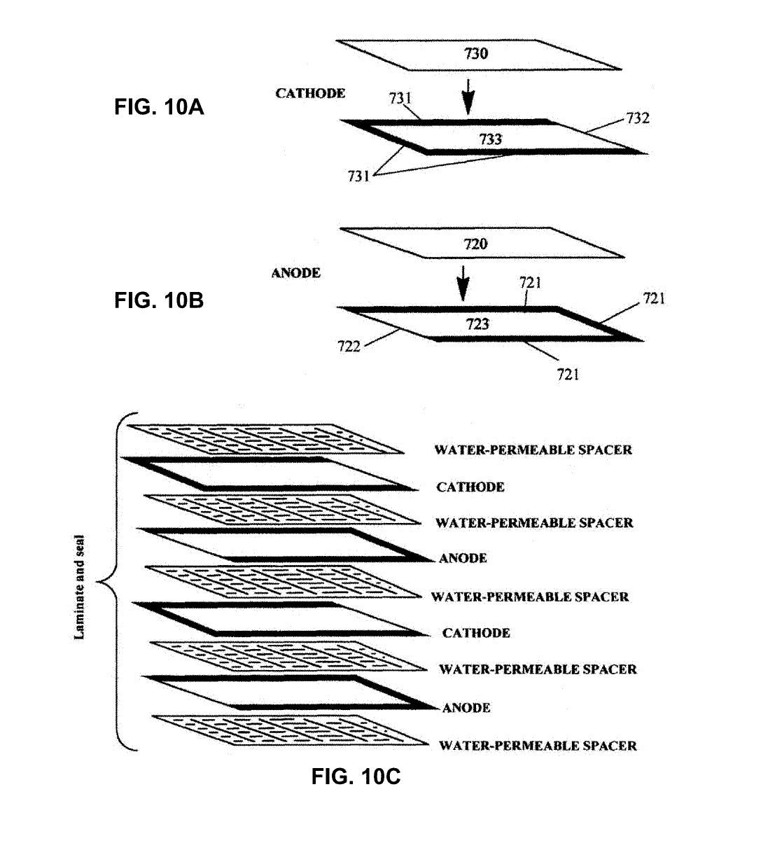

An alternative arrangement is depicted in FIG. 9C. In this arrangement, the collection tube is not segmented into a forward and a rear collection chamber. Rather the tube is segmented down its length into two separate chambers. The flat-sheet anodes and cathodes are attached to the tube in such a way that the unsealed edges of the anodes empty into one of these chamber and the unsealed edges of the cathodes empty into the other of these chambers. Thus, when spiral wound as shown in 940 in FIG. 9C, and modularised by encasing in a polymer case 950, the module allows for water to transit through as shown in FIG. 9C. When a suitable voltage is applied to such a module, hydrogen gas is generated and exits the module from one of the segmented gas channels within the collection tube, while oxygen is generated and exits the module from the other of the segmented chambers as shown. Water electrolysis modules of the type depicted in 950 typically display high internal surface area but a relatively small overall footprint. A range of other options exist to fabricate a spiral wound water electrolysis module. In order to demonstrate some of the other, non-limiting options for fabricating spiral wound electrolysers, reference is made to FIGS. 10A-C and 11A-C.

FIGS. 10A-C illustrate another approach to the manufacture of a spiral wound electrolyser module. The cathode 730 is sealed 731 at three of the four edges, with the fourth edge left unsealed 732 as shown (FIG. 10A). The anode 720 is sealed 721 at three of the four edges, with the fourth edge left unsealed 722 as shown (FIG. 10B). The anodes and cathodes are then stacked as shown in FIG. 10C with intervening flow-channel spacers of the type depicted in FIG. 7. Note that the unsealed edges of the anodes all line up with each other along the left edge, whereas the unsealed edges of the cathodes line up with each other along the right edge.

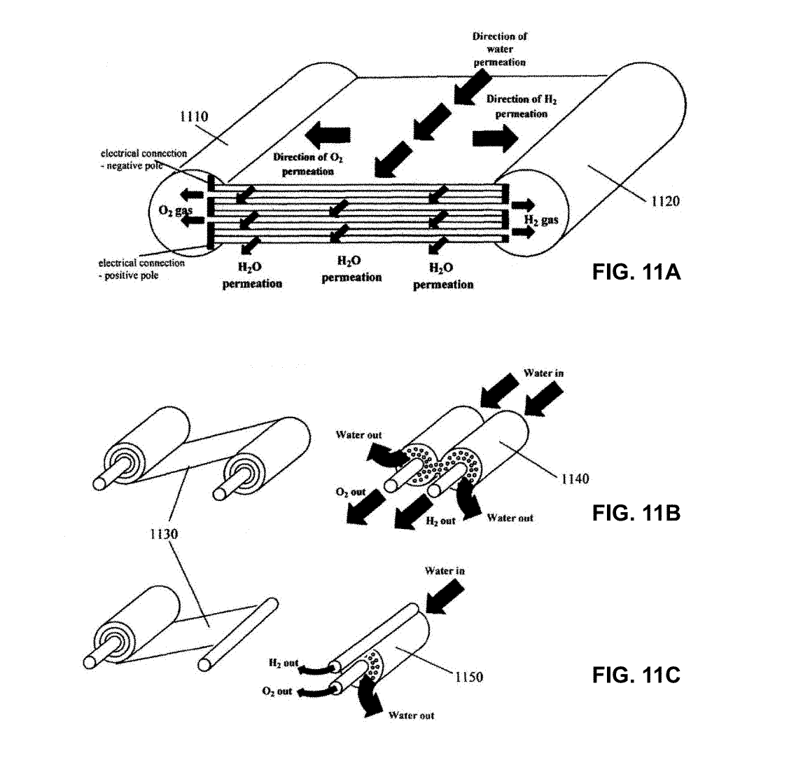

FIG. 11A depicts how the assembly in FIG. 10C may be turned into a water electrolyser of the present invention. A hollow tube 1110 is attached to the left side of the assembly in FIG. 10C as shown in FIG. 11A. The anodes are attached to the tube 1110 in such a way that their unsealed edges open into the internal vacancy of the tube 1110. Another tube 1120 is attached to the right side of the assembly. The cathode is attached to the tube 1120 in such a way that their unsealed edges open into the internal vacancies of the tube 1120. Thus, when water permeates through the assembly and a suitable voltage is applied, the hydrogen gas that is generated is collected by the right-hand tube 1120, while the oxygen gas generated is separately collected by the left hand tube 1110.

When this arrangement is spiral wound 1130 (FIGS. 11B-C), two possible modular arrangement may be fabricated. The modular arrangement shown in 1140 in FIG. 11B comprises of two, roughly equally thick, spiral wound elements encased by a polymer casing 1140. The casing allows water to pass through the module as shown. The two inner tubes separately collect and yield the hydrogen and oxygen that is generated. The modular arrangement shown in 1150 in FIG. 11C comprises of one spiral wound element incorporating the left hand collection tube (oxygen generation) and encased by a polymer casing 1140, with the other collection tube (hydrogen generation) located on the outer surface of the module. The casing allows water to pass through the module as shown. The inner tube collects and supplies the oxygen that is generated. The outer tube collects and supplies the hydrogen that is generated.

Because such water electrolysis modules have a high internal surface area but a relatively small overall footprint or external area, they can be operated at relatively low overall current densities. A typical current density would be 10 mA/cm², which is two orders of magnitude smaller than the current densities currently employed in most commercial water electrolysers. At so low a current density, it is possible to generate hydrogen with near to or greater than 90% energy efficiency HHV. The electrical power requirements and options for series and parallel electrical arrangement of the individual cells in such modules are discussed in detail in Example 6.

### Example 3: An Electrochemical Reactor Comprising a Multi-Layer, Hollow-Fibre Configuration (‘Hollow-Fibre Module’)

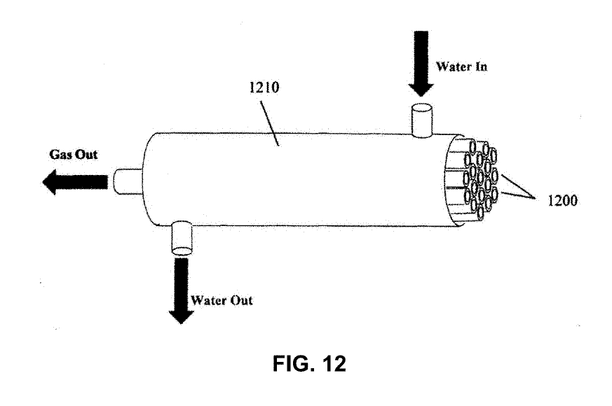

FIG. 12 depicts schematically and in principle how a set of hollow-fibre anode and cathode electrodes may be configured for an example water electrolyser. A set of conductive catalytic hollow-fibre materials 1200 may be aligned and housed within a casing 1200 that allows for water to be transported around the array of hollow-fibre materials. To construct a hollow-fibre water electrolyser reactor, one can start with the hydrophobic hollow-fibre material with built-in gas spacer 200 depicted in FIG. 4B. Upon the surface of this material a conductive layer is deposited, typically using vacuum metallization. In the case of an alkaline electrolyser, the conductive layer is typically nickel (Ni). Using this technique, Ni layers of 20-50 nm may be deposited. The Ni-coated materials may then be subjected to dip-coating using electroless nickel plating, to thicken the conducting Ni layer on their surface. After this, a catalyst may be deposited upon the conducting Ni surface. A range of possible catalysts exist and are known in the art. Methods of depositing them are described in Example 3.

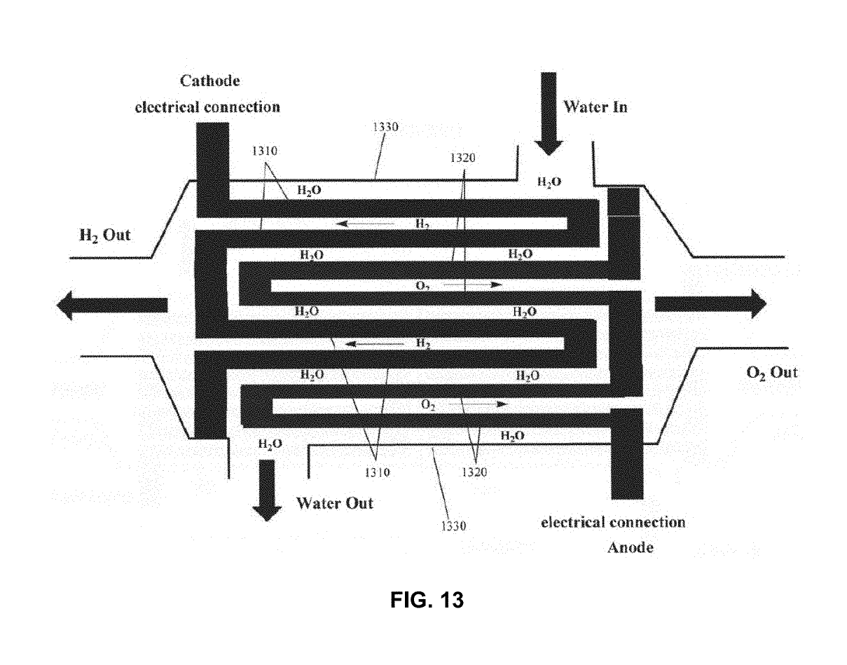

To ensure that the hollow fibre anode or cathode thus prepared is electrically isolated from other electrodes when in operation, it would typically be further coated with a layer of porous Teflon or sulfonated fluorinated polymer using a standard dip-coating procedure well-known in the art. By means such as these, the hollow-fibre anode 1320 and hollow-fibre cathode 1310 in FIG. 13 may be prepared. The cathodes and anodes thus prepared are then sealed at their both ends using simple heat sealing or a laser sealing process. If necessary, the hollow-fibre gas permeable materials may be sealed prior to the deposition of the conductive and catalytic layers upon their surface.

The cathode and anode hollow fibres are then interdigitated as shown schematically in FIG. 13, with their ends lying in a non-interdigitated fashion on opposite sides. In FIG. 13, the anode hollow fibres 1320 have their non-interdigitated ends on the right and the cathode hollow fibres 1310 have their non-interdigitated ends on the left. A conductive adhesive is then cast about the non-interdigitated ends of the anode hollow-fibres 1320. The adhesive is allowed to set, whereafter a conductive adhesive is cast about the non-interdigitated ends of the cathode hollow-fibres 1310. After the two adhesives are set, they are sawn through with a fine bandsaw, opening up the one end of the sealed hollow fibres. The anode hollow fibres 1320 are now open on the right-hand side of the interdigitated assembly (as shown in FIG. 13), while the cathode hollow fibres 1310 are open at the left hand side of the interdigitated assembly (as shown in FIG. 13). The interdigitated assembly is then encased in a polymer case 1330 which allows water to pass between the interdigitated hollow-fibres but not into their internal gas collection channels.

The anodes and cathodes are then preferably, though not necessarily, connected in parallel with each other (unipolar design), with the negative external pole connected to the left-hand (cathode) conducting adhesive plug and the positive external pole connected to the right-hand (anode) conducting adhesive plug. Bipolar designs are also possible in which individual fibres, or bundles of fibres are connected in series with each other so that hydrogen is generated in the hollow-fibres open at the left-hand side of the electrolyser and oxygen in the hollow-fibres open at the right-hand side of the electrolyser.

Upon applying an electrical voltage to the two conducting adhesive plugs at either end of the interdigitated arrangement, in the presence of water, hydrogen gas is formed at the surface of the cathode hollow-fibres. As shown in FIG. 4B, the hydrogen passes through the hydrophobic pores 240 of the hollow fibre into the internal gas collection channel 260, without forming bubbles at the surface of the cathode. The hydrogen is channeled as shown in FIG. 13 into the hydrogen outlet at the left of the reactor in FIG. 13.

At the same time, oxygen is generated at the surface anode hollow-fibres. As shown in FIG. 4B, the hydrogen passes through the hydrophobic pores 240 of the hollow fibre into the internal gas collection channel 270 of the anodes, without forming bubbles at the surface of the anode. The oxygen is channeled as shown in FIG. 13 into the oxygen outlet at the right of the reactor in FIG. 13.

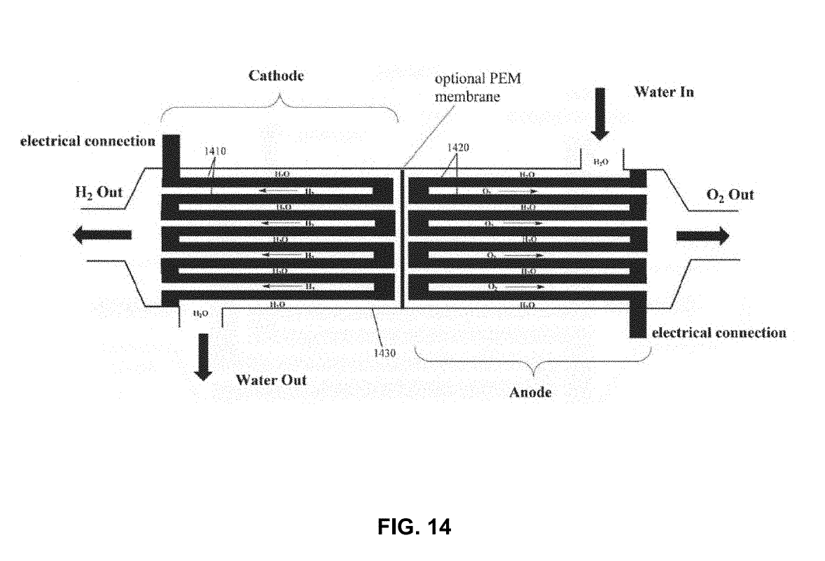

Thus, the module depicted in FIG. 13 generates hydrogen and oxygen upon application of a suitable voltage and when water is passed through the module. A range of other options exist to fabricate a hollow-fibre water electrolysis module of the present invention. In order to demonstrate another, non-limiting option, reference is made to FIG. 14.

In FIG. 14, the anode and cathode hollow fibres have not been interdigitated, but have instead been incorporated in two separate multi-layer arrangements that face each other. On the left hand side, a set of parallel hollow-fibre cathodes 1410 have been located together within the module housing 1430, while on the right hand side, a set of parallel hollow-fibre anodes 1420 have been located together in the module housing 1430. A proton exchange membrane or material may optionally be present between the cathode and the anode hollow-fibres.

Upon applying an electrical voltage to the two conducting adhesive plugs at either end of the module, in the presence of a suitable aqueous electrolyte filling the module, hydrogen gas is formed at the surface of the cathode hollow-fibres 1410 and is transported to the hydrogen exit via the pores of the materials and their hollow interiors. Oxygen gas is similarly formed at the surface of the anode hollow-fibres 1420 and is transported to the oxygen exit via the pores of the materials and their hollow interiors. Thus, the module depicted in FIG. 14 generates hydrogen and oxygen upon application of a suitable voltage and when the module is filled with a suitable aqueous electrolyte.

Because such hollow-fibre based water electrolysis modules have a high internal surface area but a relatively small overall footprint, they can be operated at relatively low overall current densities. A typical current density would be 10 mA/cm², which is two orders of magnitude smaller than the current densities currently employed in most commercial water electrolysers. At so low a current density, it is possible to generate hydrogen with near to or greater than 90% energy efficiency HHV. The electrical power requirements and options for series and parallel electrical arrangement of the individual cells in such modules are discussed in detail in Example 6.

### Example 4: Assembling Water Electrolyser Modules into Electrolyser Plants

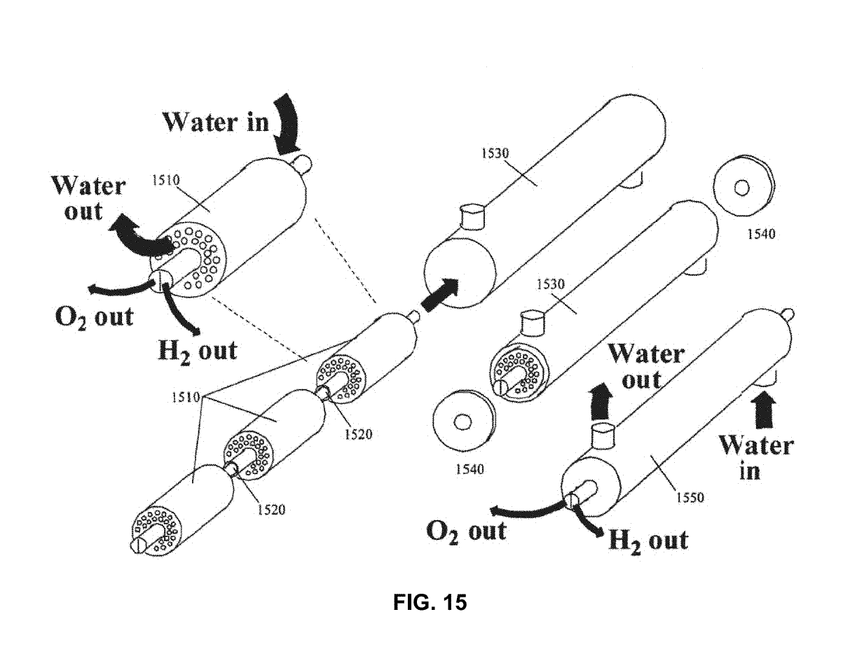

FIG. 15 depicts schematically how water electrolyser modules may be assembled into larger units that constitute an electrolyser plant. Three modules 1510 (of the same type described as 950 in FIG. 9C) are attached to each other via robust “quick-fit” fittings 1520, that correctly connect the separate hydrogen and oxygen gas collections channels together in a secure way. The combined modules are then pushed into a thick metal tube 1530 which is sealed with a thick metal cover plate 1540 at each end. The cover plates 1540 allow for the transportation of water through the tube and permit the gas collection tubes to protrude outside of the tube. Water is then passed through the sealed tube 1550 as shown, while a voltage is applied to the combined anodes and cathodes in the modules within the tube. The resulting hydrogen and oxygen that is generated is collected as shown at the bottom right of FIG. 15.

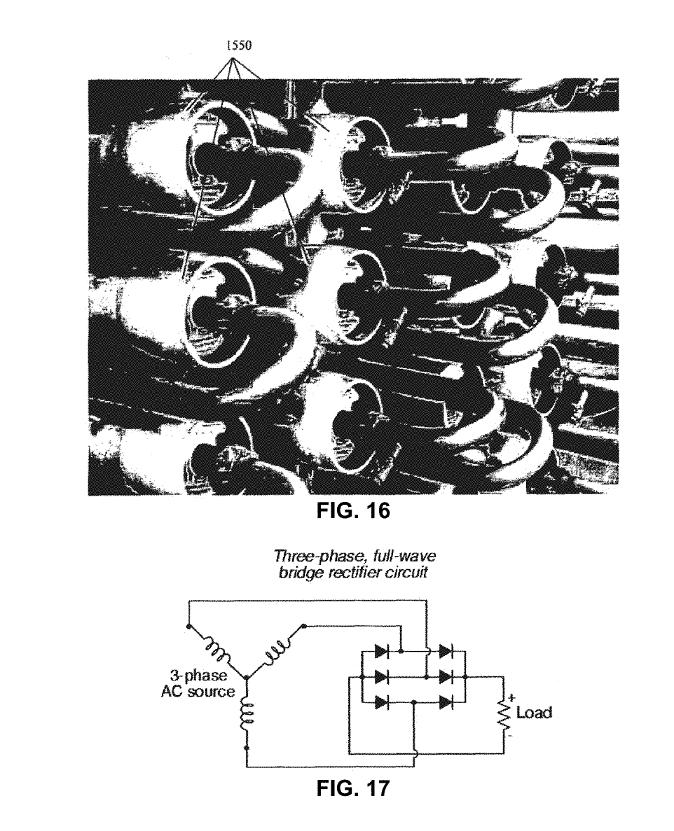

The tube 1530 acts as a second containment vessel for the hydrogen that is generated and thereby carries out a safety function for the electrolyser. The configuration depicted in FIG. 15 is for a water electrolyser plant. In such plants, multiple tubes containing modules may be combined as shown in the photograph in FIG. 16. Tubular arrangements of water electrolyser modules may be combined in a similar way.

### Example 5: Fabricating an Electrolyser to Generate Pressurised Hydrogen

In many applications, it is desirable to produce hydrogen at a pressure greater than atmospheric. For this reason, most commercial electrolysers generate pressurised hydrogen. For example, commercial alkaline electrolysers generally produce hydrogen at pressures of 1-20 bar. In order to generate pressurised hydrogen in an example electrolyser, it is necessary to pressurise the water, whilst simultaneously ensuring that that a stable gas-liquid interface is maintained at the breathable electrodes under the applied pressure. That is, the breathable electrode must typically be so designed that water will not be pushed through the pores into the associated gas channels under the applied pressure.

The equation relating the wetting of the pores of a porous material to the liquid used and the pressure differential is Washburn's equation:

$${P}_{C} = \frac{2 γ}{r} cos φ$$

where P_{c}=the capillary pressure, r=the pore radius, γ=the surface tension of the liquid, and 4=the contact angle of the liquid with the material. Using this equation, one may calculate the optimum pore size (for round pores) to achieve the desired, distinct liquid-gas interface at a particular differential pressure.

For example, for a polytetrafluoroethylene (PTFE) material in contact with liquid water, the contact angles are typically 100-115°. The surface tension of water is typically 0.07197 N/m at 25° C. If the water contains an electrolyte such as 1 M KOH, then the surface tension of the water typically increases to 0.07480 N/m. Applying these parameters to the Washburn equation yields the following data:

| | Contact | | | |
|---|---|---|---|---|
| | Angle of | | | |
| | the liquid | Pressure to | | |
| Pore size of | with the | wet/dewet | Pressure to | Pressure to |
| material, | material, | pore, Pa | wet/dewet | wet/dewet |
| micrometers | degrees | (N/m2) | pore, Pa (bar) | pore, Pa (psi) |
| 10 | 115 | 6322 | 0.06 | 0.9 |
| 5 | 115 | 12645 | 0.13 | 1.8 |
| 1 | 115 | 63224 | 0.63 | 9.2 |
| 0.5 | 115 | 126447 | 1.26 | 18.3 |
| 0.3 | 115 | 210746 | 2.11 | 30.6 |
| 0.1 | 115 | 632237 | 6.32 | 91.7 |
| 0.05 | 115 | 1264474 | 12.64 | 183.3 |
| 0.025 | 115 | 2528948 | 25.29 | 366.7 |
| 0.013 | 115 | 4863361 | 48.63 | 705.2 |
| 0.01 | 115 | 6322369 | 63.22 | 916.7 |
| 10 | 100 | 2598 | 0.03 | 0.4 |
| 5 | 100 | 5196 | 0.05 | 0.8 |
| 1 | 100 | 25978 | 0.26 | 3.8 |
| 0.5 | 100 | 51956 | 0.52 | 7.5 |
| 0.3 | 100 | 86593 | 0.87 | 12.6 |
| 0.1 | 100 | 259778 | 2.60 | 37.7 |
| 0.05 | 100 | 519555 | 5.20 | 75.3 |
| 0.025 | 100 | 1039111 | 10.39 | 150.7 |
| 0.013 | 100 | 1998290 | 19.98 | 289.8 |
| 0.01 | 100 | 2597777 | 25.98 | 376.7 |

While many PTFE materials have oblong, not round pores, this data indicates that for a 1 bar pressure differential across the breathable materials in a liquid-to-gas transformation involving 1 M KOH (aq) and PTFE materials where the contact angle was 115°, the pores should preferably have a radius of less than 0.5 microns, more preferably less than 0.25 microns, and still more preferably around 0.1 microns or lower. In this way there would be a diminishing possibility of an applied pressure causing water to be driven into the gas channels.

If the contact angle were 1000, then for a 1 bar pressure differential across the material in a liquid-to-gas transformation involving 1 M KOH (aq) and PTFE materials, the PTFE material pores should preferably have a radius or other characteristic dimension of less than 0.1 microns, more preferably less than 0.05 microns, and still more preferably about 0.025 microns or lower.

### Example 6: The Power Requirements of Electrolysers. Tailoring the Electrolyser to the Available Three-Phase Power for Maximum AC to DC Conversion Efficiency

As noted earlier, individual anode-cathode cells within modules of the types depicted in 950, 1140, 1150, 1210, 1330, and 1430 may be connected in series or parallel, or combinations thereof. Modules containing cells in parallel electrical arrangements are termed unipolar modules. Modules containing cells in series electrical arrangements are termed bipolar modules (see, for example, FIGS. 9D-E). Moreover, the modules (e.g. 1510 in FIG. 15) may themselves be electrically connected in series or parallel.

The overall electrical arrangement—whether cells are connected in series or parallel, or combinations thereof—significantly affects the electrical power requirements for the electrolyser. In general it is desirable, for reasons of cost, energy efficiency, and complexity of design, to construct the overall electrolyser to utilize a higher overall voltage and a lower overall current. This is because the cost of electrical conductors increases as the current load increases, whereas the cost of AC-DC rectification equipment per unit output decreases as the output voltage increases. Still more preferably, because DC power is required, the overall electrolyser should be constructed in such a way that the electrical losses involved in converting residential or industrial AC power to DC are minimized to, ideally, well less than 10%. Ideally, the power requirements of the overall electrolyser configuration will be matched to the three-phase residential or industrial power supply that is available. This ensures virtually 100%/o efficiency in AC to DC conversion.

To illustrate the various permutations discussed above, reference is made to an example of a module of the types depicted in 950, 1140, 1150, 1210, 1330, and 1430. For the purposes of the example it will be assumed that each module is so constructed as to contain 20 individual cells containing one breathable anode and one breathable cathode of 1 m² each, where each cell operates at 1.6 V DC (=93% energy efficiency HHV) and a current density of 10 mA/cm². Under these conditions, each cell will generate 90 grams of hydrogen per day (24 hours), and each module will generate 1.8 kg of hydrogen per day.

The permutations for the electrical power requirements of a module of this type would be as follows:
(1) If the module was unipolar with the cells arranged exclusively in parallel, then it would require a power supply capable of providing 1.6 Volts DC and 2000 Amps of current (3.2 kW overall).
(2) If the module was bipolar with the cells arranged exclusively in series, then it would require a power supply capable of providing 32 Volts DC and 100 Amps of current (3.2 kW overall).
   In general, the bipolar module would be cheaper, more efficient, and less complex to power as it would employ a lower current and higher voltage.

If 60 modules of the above types were electrically combined, then this could, again, be in parallel or series. The permutations for the power requirements are as follows:
(1) In a parallel arrangement of unipolar modules, the overall power requirement would be 1.6 Volts DC and 120,000 Amps (192 kW overall)
(2) In a series arrangement of unipolar modules, the overall power requirement would be 96 Volts DC and 2000 Amps (192 kW overall)
(3) In a parallel arrangement of bipolar modules, the overall power requirement would be 32 Volts DC and 6,000 Amps (192 kW overall)
(4) In a series arrangement of bipolar modules, the overall power requirement would be 1920 Volts DC and 100 Amps (192 kW overall).
   Under all of these conditions, the electrolyser will generate 108 kg of hydrogen per day.

The optimum overall electrical configuration for an example electrolyser can be determined by aiming to match its power requirement to the industrial or residential three-phase power that is available. If this can be achieved, then the power loss in going from AC to DC can be limited to essentially zero, since only diodes and capacitors are required for the rectifier, and not a transformer.

For example, in Australia three-phase mains power provides 600 Volts DC, with a maximum current load of 120 Amps. If the individual cells in the electrolyser operate optimally at 1.6 V DC and a current density of 10 mA/cm², and contain one breathable anode and one breathable cathode of 1 m² each, then the electrolyser would need 375 cells in series in order to draw 600 Volts DC. Each individual cell will then experience a voltage of 1.6 Volt DC. The overall current drawn by such an electrolyser would be 100 Amps, giving an overall power of 60 kW.

To build such an electrolyser one would combine 19 of the bipolar version of the above modules in series. This would yield 380 cells in total, each of which would experience 600/380=1.58 Volts DC. The overall current drawn by the electrolyser would be 101 Amps, which is well within the maximum current load of the Australian three-phase power supply. Such an electrolyser would generate 34.2 kg of hydrogen per 24 hour day, with near to 100% efficiency in its conversion of AC to DC electricity. It could be plugged into a standard three-phase wall socket.

The AC to DC conversion unit in the power supply required for such an electrolyser would be a very simple arrangement of six diodes and beverage—can sized capacitors wired in a delta arrangement of the type shown in FIG. 17. Units of this type are currently commercially available (for example, the “SEMIKRON—SKD 160/16—BRIDGE RECTIFIER, 3 PH, 160 A, 1600V”. Thus, the cost of the power supply would also be minimized and, effectively, trivial or non limitation overall.

Several alternative approaches exist in which the available three-phase power may be efficiently harnessed. For example, another approach is to subject the three-phase power to half-wave rectification using a very simple circuit that again utilizes only diodes and capacitors and thereby avoids electrical energy losses. An electrolyser tailored to half-wave rectified 300 Volt DC would ideally contain 187 individual cells of the above type in series. Such an electrolyser could be constructed of 9 bipolar modules connected in series, which comprise of 180 individual cells. Each cell would experience 1.67 Volts DC. The overall current drawn would be 96 Amps. Such an electrolyser would generate 16.2 kg of hydrogen per 24 hour day. It could be plugged into a standard three-phase wall socket.

### Example 7: An Electrochemical Reactor Comprising a Multi-Layer, Flat-Sheet Configuration (‘Plate-and-Frame Type Module’)

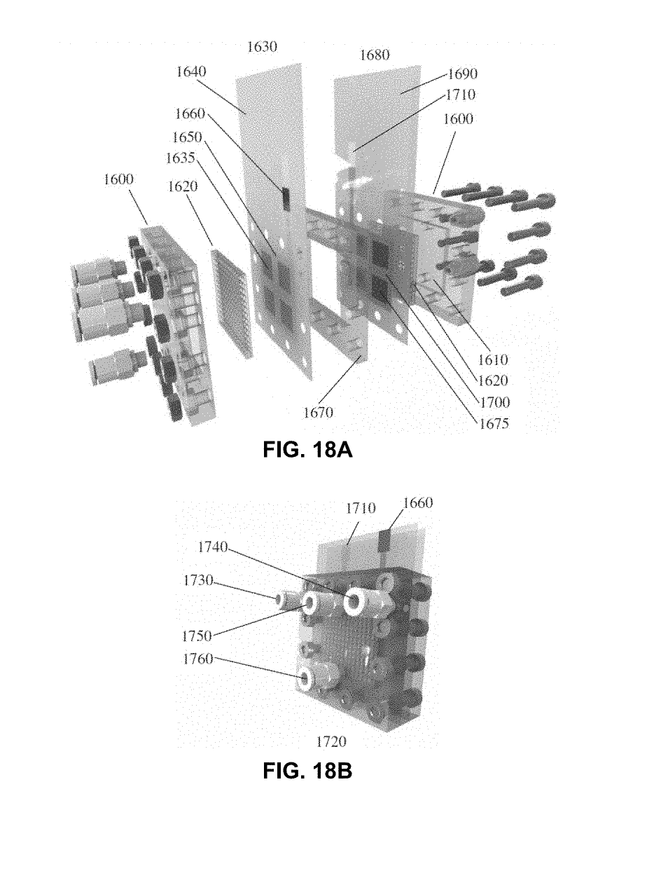

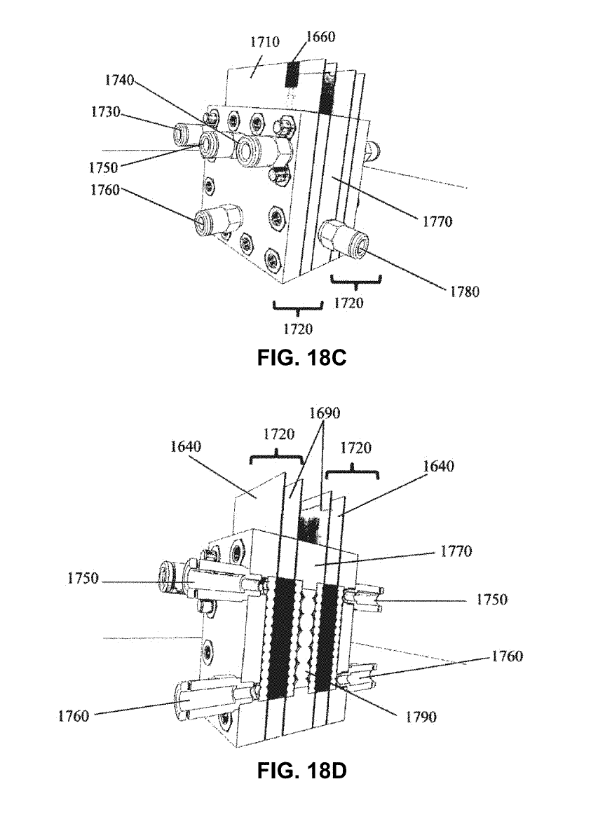

FIG. 18A provides an exploded view that illustrates how multiple, single-ply or sheet material electrodes may be combined within a ‘plate-and-frame’ type electrolyser. The following items are sandwiched or adjoined into an example electrolyser structure:
(1) Two end plates 1600, each of which contain a recessed gas collection chamber 1610 into which a porous plastic support 1620 is incorporated;
(2) A gas permeable material electrode 1630 (the anode), which can involve a Gortex® material, or like material, coated with a conductive catalytic layer on the side facing the middle of the device held within a polymer laminate 1640. The laminate also affixes a fine conductive mesh 1650 over the conductive, catalytic side of the material electrode. The mesh connects up to the copper connector 1660;
(3) A spacer 1670, within which the electrolyte (1 M KOH solution) resides;
(4) A second gas permeable material electrode 1680 (the cathode), which involves a Gortex® material, or like material, coated with a conductive catalytic layer on the side facing the middle of the device held within a polymer laminate 1690. The laminate also affixes a fine conductive mesh 1700 over the conductive, catalytic side of the material electrode. The mesh connects up to the copper connector 1710.

When screwed together, or otherwise attached together or joined, for example by glues, adhesives or melt processes, as shown in FIG. 18B, then assembly 1720 may act as a highly efficient electrolyser. Aqueous solution (1 M KOH) is introduced into the space between the electrodes via ports 1730 and 1740. The water fills the volume within spacer 1670. When an electrical voltage is then applied over the copper connectors 1660 and 1710, then the water is split into hydrogen and oxygen. The gases move through their respective material electrodes. Oxygen gas exits the device at ports 1750 and 1760. Hydrogen exits the device at the corresponding ports on the back side of assembly 1720.

Multiple such assemblies may be combined into a multi-layer assembly. FIGS. 18C-D illustrate how this may be done. In FIGS. 18C-D, two assemblies 1720 are combined by incorporating a gas collecting spacer unit 1770 between them. The spacer unit contains a hydrogen outlet 1780, that collects hydrogen from each of the adjacent assemblies 1720. To facilitate this arrangement, both of the cathodes 1690 of assemblies 1720 are attached to the spacer 1770, which has a porous internal structure 1790, through which the generated hydrogen may pass prior to exiting at outlet 1780. The anodes 1640 of assemblies 1720 are located on the outside of the stack, causing oxygen to be transmitted via outlet 1750 and 1760, on the outer sides of the resulting ‘plate-and-frame’ electrolyser.

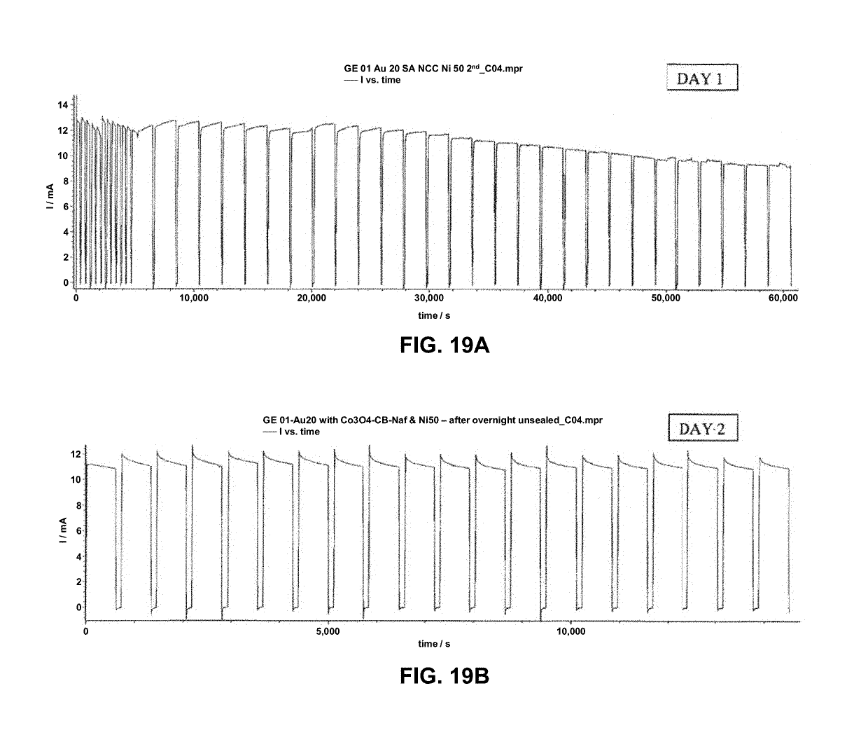

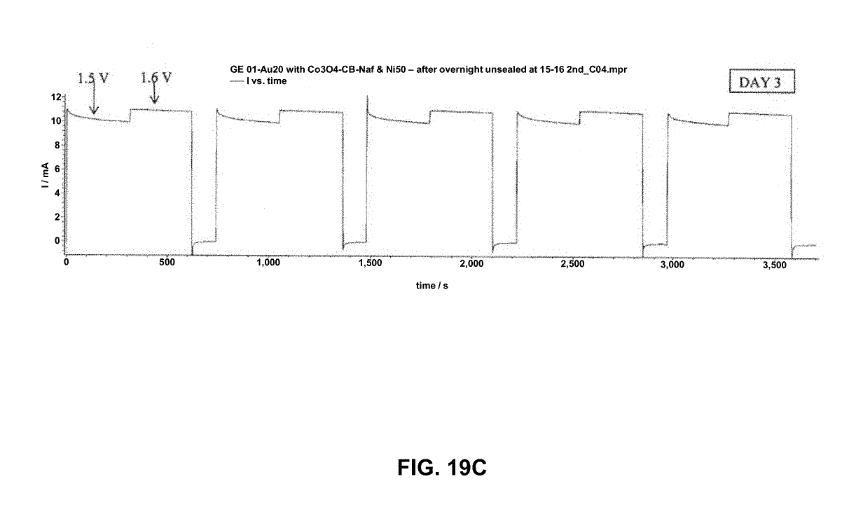

FIGS. 19A-C depict data for the operation of the device shown in FIGS. 18A-B at an applied cell voltage of 1.6 V (94% electrical efficiency, HHV), over three days of operation, with repeated, intermittent ‘on’ and ‘off’ switching. As can be seen, the device generates gases at a relatively constant rate, consuming around 10-12 mA/cm² of current in doing so. During the third day of operation (FIG. 19C), the device was tested at both 1.5 V (99% electrical efficiency, HHV) and 1.6 V (94% electrical efficiency, HHV), as shown.

Multiple assemblies of this type may be combined into a single, multi-layer ‘plate-and-frame’ type electrolyser, as shown in FIGS. 18C-D.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1-27. (canceled)

28. A method of making a water splitting device, the method comprising:
forming a first breathable electrode, wherein the step of forming comprises:
depositing a conductive layer on a polymer material;
wherein the polymer material is porous, hydrophobic, and gas permeable; and
wherein the conductive layer comprising nickel;
depositing a catalyst layer over the conductive layer; and
joining the catalyst layer with a conductive structure, the conductive structure being free-standing, planar, and porous; and
assembling the first breathable electrode and a second electrode in the water splitting device, wherein the water splitting device further comprises an aqueous electrolyte.

29. The method of claim 28, wherein the free-standing, planar, porous conductive structure comprises a metal mesh, grid, or felt.

30. The method of claim 28, wherein the polymer material is a hollow flat sheet.

31. The method of claim 30, wherein the sheet has first and second faces, and wherein the conductive layer and the catalyst layer are deposited on the first face.

32. The method of claim 31, further comprising depositing a secondary conductive layer on the second face of the sheet, and then depositing a catalyst on the secondary conductive layer.

33. The method of claim 28, wherein the polymer material is in the form of a hollow fiber.

34. The method of claim 28, wherein the conductive nickel layer has a thickness of 20 to 50 nm.

35. The method of claim 28, further comprising sealing a portion of the polymer material after depositing the catalyst layer.

36. The method of claim 28, further comprising dip-coating an additional layer of nickel onto the conductive nickel layer before depositing the catalyst layer.

37. The method of claim 28, further comprising applying a layer of a porous fluorinated polymer after depositing the catalyst layer.

38. The method of claim 28, wherein the polymer material is electrically insulating.

39. The method of claim 28, further comprising applying a pressure greater than atmospheric to the aqueous electrolyte.

40. The method of claim 39, wherein the applied pressure is greater than a pressure on a gas-side of the polymer material.

41. The method of claim 28, wherein the first breathable electrode is an anode or a cathode, and the second electrode is the other of the anode or the cathode.

42. The method of claim 28, wherein the second electrode is a second breathable electrode, the method comprising forming the second breathable electrode, wherein forming the second breathable electrode comprises:
depositing a second conductive layer on a second polymer material;
wherein the second polymer material is porous, hydrophobic, and gas permeable; and
wherein the second conductive layer comprising nickel;
depositing a second catalyst layer over the second conductive layer; and
joining the second catalyst layer with a second conductive structure, the second conductive structure being free-standing, planar, and porous.
